(19) United States
(12) Patent Application Publication
(10) Pub. No.: US 2017/0091685 A1
(43) Pub. Date: Mar. 30, 2017

(54) METHOD FOR ASSIGNING FEATURES TO A SPACE IN A PROJECT MANAGEMENT SYSTEM

(71) Applicant: WAMOOZLE INC., King City (CA)

(72) Inventor: Walter KARABIN, King City (CA)

(21) Appl. No.: 15/089,469

(22) Filed: Apr. 1, 2016

Related U.S. Application Data
(63) Continuation-in-part of application No. 14/746,808, filed on Jun. 22, 2015.

(51) Int. Cl. G06Q 10/06; G06Q 50/08

(52) U.S. Cl. CPC G06Q 10/06313; G06Q 50/08

(57) ABSTRACT

A computer-implemented method for organizing project information based on the location where project resources are bound, and/or whereby information and/or communications are captured in the context of the location that the information and/or communications pertains to, and/or a collaborative platform for facilitating communication between stakeholders to enable the stakeholders to work in tandem with the same information, wherein the information is organized with respect to location to support a particular workflow.

### CROSS-REFERENCE TO RELATED APPLICATIONS

This application is a continuation-in-part of Non-Provisional application Ser. No. 14/746,808 filed on Jun. 22, 2015.

### FIELD OF THE INVENTION

The present invention relates to a project management platform, more particularly it relates to a method and system for capturing, and organizing information in relation to a place for which the project resources are bound.

### DESCRIPTION OF THE RELATED ART

Project management involves coordinating various aspects of a project, and typically includes a plurality of elements such as personnel, materials, processes and facilities. Project managers are increasingly faced with a number of challenges related to cost, scheduling, quality, project performance, including communication between project stakeholders such as project managers, contractors, sub-contractors, trades, and clients. In most projects, it is not uncommon that unrealistic timelines are set, or that the vision and goals are not well-defined, and scope changes are not properly managed, or that risk is not properly managed and resources are not accurately determined or allocated.

At present, the market is awash with project management software tools which promise to assist project managers involved, however, not a single tool includes a comprehensive feature set for facilitating and managing project data capture. Accordingly, project managers are forced to cobble up different tools to achieve this goal. Not only is such a practice costly, it is also inefficient since valuable time is wasted inputting information into multiple systems. In addition, these disparate tools are seldom interoperable with each other and/or require expert knowledge to integrate them. Consequently, key information and crucial data related to the project is often not captured or is erroneously inputted, and therefore crucial project data may be lost, which may result in inaccurate metrics, wasted resources, and increased costs. Furthermore, these project management software tools are not tailored to the needs or workflows of any particular industry, such as home renovations, as they primarily organize information by time, resources, or person. This approach is largely deemed as being non-intuitive since most people view work in terms of places and tasks associated with those places.

It is an object of the present invention to mitigate or obviate at least one of the above-mentioned disadvantages.

### SUMMARY OF THE INVENTION

In one of its aspects, there is provided, in a project management system, a computer-implemented method for managing information related to at least one project; said method having instructions stored in a computer-readable medium and executable by a processing structure to cause said processing structure to at least:
receive a user-defined project identifier associated with said at least one project;
assign a unique place identifier to a location of said at least one project, and store said unique place identifier to form a first level of a hierarchical data structure in a database;
assign a unique sub-place identifier to at least one sub-location of said at least one project, and store said unique sub-place identifier to form a second level of said hierarchical data structure in said database;
provide a first workflow process customized for said at least one project, and said first workflow process comprising at least one space feature category type associated with said at least one location and/or said at least one sub-location, and provide a second workflow process customized for said project, and said second workflow process comprising at least one global feature category type associated with a plurality of said at least one locations and/or said at least one sub-locations;
provide a space feature library having a plurality of said at least one space feature category types corresponding to said first workflow process, and a global feature library having a plurality of said at least one global feature category types corresponding to said second workflow process; and
receive a selection of at least one of said first workflow process and said second workflow process for use in said at least one project.

In another of its aspects, there is provided a project management system, a computer-implemented method for managing information related to at least one project; said method having instructions stored in a computer-readable medium and executable by a processing structure to cause said processing structure to at least:
receive a user-defined project identifier associated with said at least one project;
assign a unique level identifier to a hierarchical level of said at least one project, and
   store said unique level identifier to form a first level of a hierarchical data structure in a database;
assign a unique sub-level identifier to at least one sub-level of said at least one project, and store said unique sub-level identifier to form a second level of said hierarchical data structure in said database;
provide a first workflow process customized for said at least one project, and said first workflow process comprising at least one level feature category type associated with said at least one level and/or said at least one sub-level, and provide a second workflow process customized for said at least one project, and said second workflow process comprising at least one global feature category type associated with a plurality of said at least one levels and/or said at least one sub-levels;
provide a level feature library having a plurality of said at least one level feature category types corresponding to said first workflow process, and a global feature library having a plurality of said at least one global feature category types corresponding to said second workflow process; and
receive a selection of at least one of said first workflow process and said second workflow process for use in said at least one project.

In another of its aspects, there is provided a computer program product comprising a non-transitory computer readable medium embodying computer readable code for managing information related to at least one project, said computer program product comprising:
computer readable code for creating a window on a graphical user interface to comprise at least one location and at least one sub-location pertaining to said project and at least one project element type pertaining to one of said location and said at least one sub-location;
responsive to user selection of said at least one location and said at least one sub-location, computer readable code for displaying an object attributes window including a plurality of selectable attributes associated with said at least one location, said at least one sub-location;
provide a first workflow process customized for said at least one project, and said first workflow process comprising at least one space feature category type associated with said at least one location and/or said at least one sub-location, and provide a second workflow process customized for said project, and said second workflow process comprising at least one global feature category type associated with a plurality of said at least one locations and/or said at least one sub-locations;
provide a space feature library having a plurality of said at least one space feature category types corresponding to said first workflow process, and a global feature library having a plurality of said at least one global feature category types corresponding to said second workflow process; and
receive a selection of at least one of said first workflow process and said second workflow process for use in said at least one project.

In another of its aspects, there is provided a communication method between a plurality of participants associated with a project, said project having at least one task comprising a plurality of sub-tasks, the method having the steps of:
determining a location and at least one sub-location where said at least one task is performed;
organizing at least one object type pertaining to said project, said at least one object type comprising one of said location, time, personnel, equipment, products, services;
assigning a first attribute to said location and a second attribute to said at least one sub-location, at a third attribute to said at least one of object type, wherein said attributes comprise at least one of a feature, metrics, descriptive information, personnel, time, work, said at least one task, said at least one sub-task, communications, notes, and media;
presenting on a user interface a title of said project, said location and at least one selectable sub-location and at least one selectable attribute
composing a message related to said location by:
   selecting at least one of said sub-locations and selecting at least one of said attributes;
   inputting data in a free-form user interface; and
whereby said message comprises said location as an originator of said message, and
   whereby one of said sub-locations and said at least one of said attributes forms a subject of said message and other of said attributes form a body of said message;
   providing said message to at least one of said plurality of participants; and
   whereby said at least one of said plurality of participants updates said message following said aforementioned steps; and
   whereby said message pertains to one of said location and at least one of said selectable attributes, and one of said location and at least one of said selectable attributes contribute to a communication method that is centered about one of said location and at least one of said selectable attributes rather than said participants;
   wherein said at least one feature is selected from one of a space feature library and a global feature library.

In another of its aspects, there is provided a computer program product comprising a non-transitory computer readable medium embodying computer readable code for creating an electronic message corresponding to a project, said computer program product comprising:
computer readable code for creating a window on a graphical user interface to comprise at least one location and at least one sub-location pertaining to said project and at least one project element type pertaining to one of said location and said at least one sub-location;
responsive to user selection of said at least one location and said at least one sub-location, computer readable code for displaying an object attributes window including a plurality of selectable attributes associated with said at least one location, said at least one sub-location;
responsive to user selection of one or more selectable attributes, computer readable code for associating selected attributes with said at least one location and said at least one sub-location and said at least one project element type object;
computer readable code for creating an editable free-form user interface element for population with said at least one location, said at least one selectable sub-location, said at least one object type and said plurality of selectable attributes associated therewith;
wherein said electronic message comprises said at least one location as an originator of said message, and one of said sub-locations and said at least one of said selectable attributes forms a subject of said electronic message, and said free-form content forms a body of said message; and
wherein said electronic message pertains to one of said at least one location and at least one of said plurality of selectable attributes, and wherein one of said at least one location and at least one of said plurality of selectable attributes contribute to a communication method that is centered about one of said location and at least one of said selectable attributes rather than project participants.

In another of its aspects, there is provided a communication method associated with a project, said project having at least one task with a plurality of sub-tasks in a workflow process, the method having the steps of:
determining a location and at least one sub-location where said at least one task is performed;
organizing at least one project element type pertaining to said project, wherein said at least one project element type comprises resources associated with said project including at least of one of time, personnel, equipment, products, and services;
assigning a first attribute to said location and a second attribute to said at least one sub-location, at a third attribute to said at least one of object type, wherein any of said first attribute, said second attribute and third attribute comprises at least one of features, metrics, descriptive information, communications, notes, and media;
presenting on a user interface a title of said project, said location and at least one selectable sub-location and at any of said first attribute, said second attribute and third attribute;
composing a message related to one of said location and at least one of said selectable attributes by:
   selecting at least one of said sub-locations and selecting at least one of said attributes for populating an editable free-form user interface element; and
   wherein said message comprises said location as an originator of said message, and one of said sub-locations and said at least one of said attributes forms a subject of said message, and said free-form content forms a body of said message; and
   wherein said location and associated at least one of said selectable attributes contribute to a communication method that is location-centric rather than user-centric.

In another of its aspects, there is provided, in a project management system, a computer-implemented method for managing information related to at least one project, said method having instructions stored in a computer-readable medium and executable by a processing structure to cause said processing structure to at least:
assign a user-defined project identifier to said at least one project;
assign a unique place identifier to a location of said at least one project, and storing said unique place identifier to form a first level of a hierarchical data structure in a database;
assign a unique sub-place identifier to at least one sub-location of said at least one project, and storing said unique sub-place identifier to form a second level of said hierarchical data structure in said database;
assign a unique element identifier to at least one project element associated with said location and/or sub-location, said at least one project element having at least one feature, and storing said unique element identifier to form a third level of said hierarchical data structure in said database;
capture information pertaining to one said at least one project and assign said captured information to any one of said location and/or sub-location and attribute, and project element; and
whereby said assigned information is organized in terms with respect to said at least one location and/or said at least one sub-location.

In another of its aspects, there is provided, in a data processing system for a project management platform, a computer-implemented method for capturing data pertaining to at least one location of a project, the method having instructions stored in a computer-readable medium and executable by a processing structure to cause said processing structure to at least:
provide access to at least one user to said platform, wherein said at least one user has a predetermined user access privilege level to said platform;
present a graphical user interface (GUI) having a plurality of GUI objects for navigating said platform;
provide at least one input field for entering information pertaining to a title of said project, and assign a first unique identifier to said title of said project;
allow input of information pertaining to at least one location of said project, and assign a second unique identifier to said at least one location;
allow input of information pertaining to at least one sub-location of said at least one location of said project; and assign a third unique identifier to said at least one sub-location;
allow input of information pertaining to at least one attribute of said at least one sub-location of said at least one location; and assign a fourth unique identifier to said at least one attribute; and
whereby said title of said project, said at least one location, said at least one sub-location and said at least one attribute form a location-centric hierarchical structure of information pertaining to said project.

In another of its aspects, there is provided a project management system for capturing data pertaining to locations targeted in a construction project, said system having:
a project participants module having the functions of receiving and managing details of project stakeholders, such as contractors, sub-contractors, project team, vendors, trades, and clients; adding a project participant to a project team; assigning unique identifiers to members of said project team; and defining project roles of said project team;
a project place module having the functions of defining project locations; managing location-centric information related to locations or sub-locations for which project resources are bound;
a project calendar module having the functions of managing project milestone dates, allowing said project participants to identify major project milestones, enter new milestone activities; identify schedule tasks; add new schedule task; add a start date and an end date; and calculate schedule dates based on input of task data;
an Request for Quotes (RFQ) module having the functions of managing RFQs, and transmittals, submittals, additional to scope items, change orders and deficiency lists associated with said RFQs; providing to said project participants, any of a summary and/or an overview of requirements and list of proposers, details describing the scope of services requested; providing quotes based on predetermined criteria and fee analysis to allow said project participants to determine variances between estimated, actual and other costs;
a media module having the functions of uploading and cataloguing of documents, images and multimedia; and providing linking of project specific information, including at least one of a title, description, daily report and schedule;
an analytics and reporting module having the functions of analyzing information related to said project and generating reports, including at least one of a histogram, time line, bar chart, and tabular data; and providing forecasting based on resource constraints;
a communications module having the functions of exchanging and sharing of notes, multimedia, documents, comments between said project participants in a collaborative manner;
a search module having the functions querying data captured within said project management system; and
a project module having the functions of providing a summary of common project information to said project participants; providing task information to said project participants; sharing common data; providing a scope describing said project; identifying members of a project team; providing basic project data; assigning unique identifiers to each project or sub-project, place or sub-place associated with said project or sub-project and storing said unique identifiers in a database;
whereby said project information is organized by location; and
whereby said information and communications are captured in the context of a location targeted for said task in relation to said place it pertains to, to form a location-centric hierarchical structure of information pertaining to said project.

In another of its aspects, there is provided a communication method between a plurality of participants associated with a project, said project having at least one task having a plurality of sub-tasks, the method having the steps of:
determining a location and at least one sub-location where said at least one task is performed;
organizing at least one object type pertaining to said project, said at least one object type comprising one of said location, time, personnel, equipment, products, services;
assigning a first attribute to said location and a second attribute to said at least one sub-location, at a third attribute to said at least one of object type, wherein said attributes comprise at least one of features, metrics, descriptive information, personnel, time, work, said at least one task, said at least one sub-task, communications, notes, and media;
presenting on a user interface a title of said project, said location and at least one selectable sub-location and at least one selectable attribute
composing a message related to said location by:
   selecting at least one of said sub-locations and selecting at least one of said attributes;
   inputting data in a free-form user interface; and
whereby said message comprises said location as an originator of said message, and
   whereby one of said sub-locations and said at least one of said attributes forms a subject of said message and other of said attributes form a body of said message;
   providing said message to at least one of said plurality of participants; and
   whereby said at least one of said plurality of participants updates said message following said aforementioned steps; and
   whereby said message pertains to one of said location and at least one of said selectable attributes, and contribute to a communication method that is centered about one of said location and at least one of said selectable attributes rather than said participants.

In another of its aspects, there is provided a method of composing a message associated with a project, said project having at least one task having a plurality of sub-tasks, the method having the steps of:
determining a location and at least one sub-location where said at least one task is performed;
organizing at least one object type pertaining to said project, said at least one object type comprising one of said location, time, personnel, equipment, products, services, media;
assigning a first attribute to said location and a second attribute to said at least one sub-location, at a third attribute to said at least one of object type, wherein said attributes comprise at least one of features, metrics, descriptive information, personnel, time, work, said at least one task, said at least one sub-task, communications, notes, and media;
presenting on a user interface a title of said project, said location and at least one selectable sub-location and at least one selectable attribute;
composing a message related to said location by:
   selecting at least one of said sub-locations and selecting at least one of said attributes;
   inputting data in a free-form user interface; and
whereby said message comprises said location as an originator of said message, and
   whereby one of said sub-locations and said at least one of said attributes forms a subject of said message and other of said attributes form a body of said message;
   providing said message to at least one project participant; and
   whereby said at least one of said plurality of participants updates said message following said aforementioned steps; and
   whereby said message pertains to one of said location and at least one of said selectable attributes, and contribute to a communication method that is centered about one of said location and at least one of said selectable attributes rather than said at least one project participant.

Current project management systems generally rely on the obvious typical elements such as time, dates, costs, people, and tasks as their core while neglecting the actual location in which all the resources are intended to converge, that is, the place. Advantageously, in one embodiment the system or workflow process captures information and communications intuitively in terms of “place” or location to solve this discrepancy, as people naturally think and work in terms of objects and places. Information organized by “place” reflects the way in which people naturally approach and carry out project tasks, in contrast to time/resource oriented software.

Therefore, project information elements such as, costs, tasks, communications, features, attributes, times, dates, photos and notes are connected by place and provide useful, fast reports, and eliminate redundancy in report creation by means of leveraging user inputs typical to project related processes. Typical project-related processes requiring user inputs are found when a user captures, organizes, or interacts with project information in a variety of ways or applications such as word-processing, spreadsheets, electronic messages, calendar, contact lists, day-timers, paper note pads, and stand-alone software. In addition, complete details of current and past projects are organized and captured in one place; and the system provides a medium of communication that gives context to the information being exchanged i.e. place-centric. A collaborative platform which facilitates communication between stakeholders by allowing them to work in tandem with the same information is provided, wherein the information is organized to support a particular workflow. Consequently, project efficiency and profitability are substantially enhanced.

In addition, the system or workflow process provides the project stakeholders with the ability to balance competing demands, define a clear project scope, identify project risks and identify potential problems in a timely manner, provide a consistent method for monitoring and controlling project deliverables and milestones, improved communication among stakeholders, measure project performance and understand the impact of the timeline and critical path when deliverables are changed.

### BRIEF DESCRIPTION OF THE DRAWINGS

Several exemplary embodiments of the present invention will now be described, by way of example only, with reference to the appended drawings in which:

FIG. 1 is a top-level component architecture diagram of an exemplary project management system;

FIG. 2 shows a schematic diagram of a general purpose computer system;

FIG. 3a shows an exemplary embodiment of a database having a location-centric hierarchical structure of information pertaining to the project;

FIG. 3b shows a high level flow diagram illustrating exemplary process steps for building a place-centric hierarchical structure of information;

FIG. 3c shows an exemplary embodiment of another database having a location-centric hierarchical structure of information pertaining to the project resulting from the process of FIG. 3b;

FIG. 4 shows a location-centric hierarchical structure of information pertaining to the project;

FIG. 5 shows another high level flow diagram illustrating exemplary process steps for building a place-centric hierarchical structure of information;

FIG. 6 is a screenshot of an exemplary user interface;

FIG. 7 is a screenshot of an exemplary user interface;

FIG. 8 is another screenshot of an exemplary user interface;

FIG. 9 is another screenshot of an exemplary user interface;

FIG. 10 is yet another screenshot of an exemplary user interface;

FIG. 11 is yet another screenshot of an exemplary user interface;

FIG. 12 is a screenshot of an exemplary user interface;

FIG. 13 is another screenshot of an exemplary user interface;

FIG. 14 is another screenshot of an exemplary user interface;

FIG. 15 is another screenshot of an exemplary user interface;

FIG. 16 is yet another screenshot of an exemplary user interface;

FIG. 17 is yet another screenshot of an exemplary user interface;

FIG. 18 is yet another screenshot of an exemplary user interface;

FIGS. 19a to 19e are other screenshots of an exemplary user interface;

FIGS. 20a to 20l are other screenshots of an exemplary user interface;

FIGS. 21a to 21m are other screenshots of an exemplary user interface; and

FIGS. 22a to 22i are other screenshots of an exemplary user interface.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

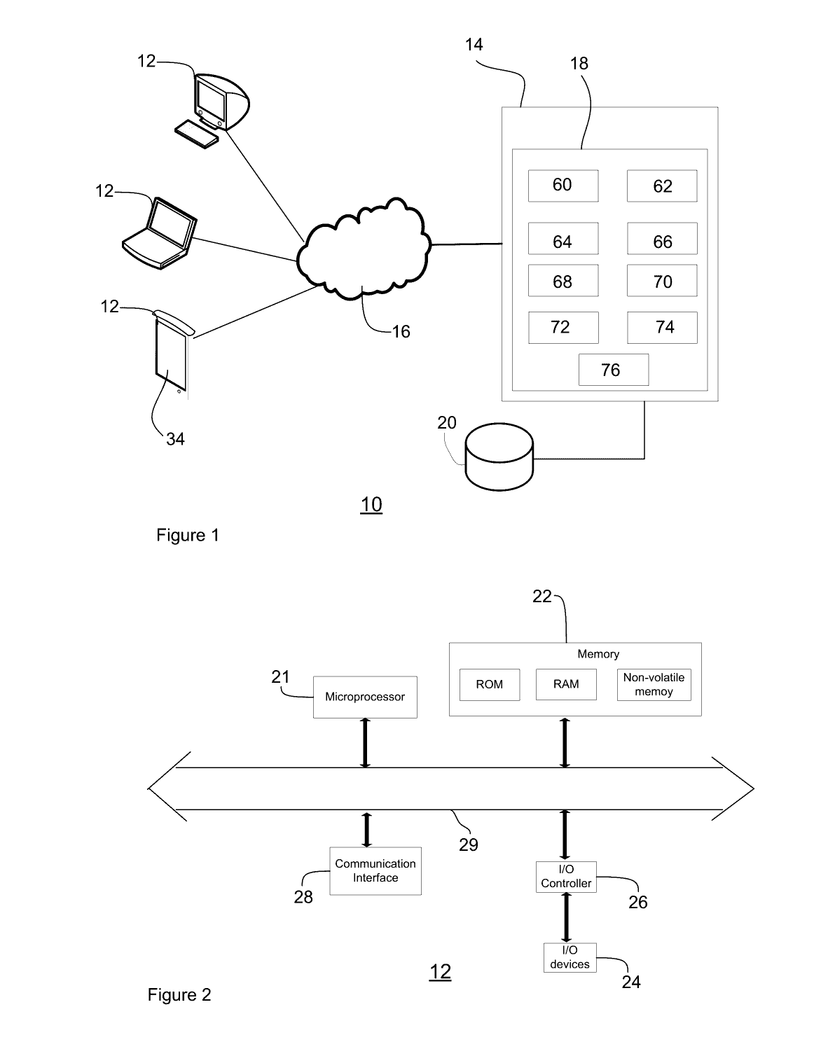

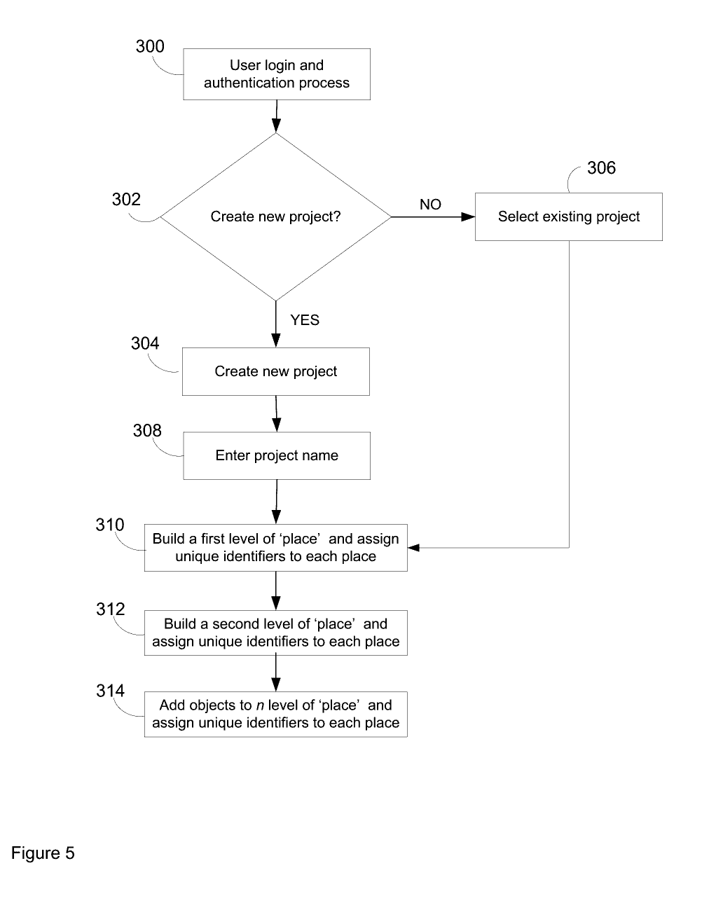

FIG. 1 shows a top-level component architecture diagram of an exemplary system, generally identified by reference numeral 10, for performing a place-centric project management process. System 10 generally includes one or more user devices 12 coupled to computing system 14 via communications network 16, such as the Internet, and/or any other suitable network. Examples of a computing system 14 may include, but are not limited to: a personal computer, a server computer, a series of server computers, a mini computer, and a mainframe computer. In one example, server computer 14 comprises project management framework module 18, and includes a project management process that may be executed by a data processing system of server computer 14, as will be described below with reference to FIG. 5. Server computer 14 includes one or more databases 20, which may be any type of data repository or combination of data repositories, which store records or other representations of data.

The methods of the invention are performed with a digital processing system, such as a conventional, general purpose computer system. Special purpose computers which are designed or programmed to perform only one function may also be used. FIG. 2 shows a schematic diagram of a user device 12 depicted as a general-purpose computer system in which a place-centric project management process operates. The general-purpose computer system 12 comprises, for example, a processing unit, such as processor 21, system memory 22. The computer system 12 also includes as input/output (I/O) devices 24 coupled to the processor 21 via an I/O controller 26. The input/output (I/O) devices 24, for example, a keyboard, mouse, trackball, microphone, touch screen, a printing device, display screen, speaker, etc. A communications interface device 28 provides networking capabilities using Ethernet, WiFi™, and/or other suitable network format, to enable connection to shared or remote drives, one or more networked computers, or other networked devices, via the communications network 16. The components of computer system 12 may be coupled by an interconnection mechanism 29, which may include one or more buses (e.g., between components that are integrated within a same machine) and/or a network (e.g., between components that reside on separate discrete machines). The interconnection mechanism 29 enables communications (e.g., data, instructions) to be exchanged between components of system 12.

Various aspects of the invention may be implemented as specialized software processes with instructions having computer readable code executable in one or more computer systems communicating over network 16. Processor 21 executes sequences of instructions contained in memory 22, such as a machine readable medium. Machine readable medium 22 includes any mechanism that provides (i.e., stores and/or transmits) information in a form accessible by a machine (e.g., a computer, network device, personal digital assistant, a smartphone, any device with a set of one or more processors, etc.). For example, machine readable media includes recordable/non-recordable media 22 (e.g., read only memory (ROM); random access memory (RAM); magnetic disk storage media; optical storage media; flash memory devices; a hard disk drive, etc.), as well as electrical, optical, acoustical or other forms of propagated signals (e.g., carrier waves, infrared signals, digital signals, etc.). Such a processor 21 usually executes an operating system which may be, for example, the Windows-based operating systems (e.g., Windows NT, Windows 7, Windows 8 operating systems) available from Microsoft Corporation, MAC OS System X operating system and iOS available from Apple Computer, Android from Google Inc., and one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

As described in more detail below, the project management module 18 may be adapted to configure server 14, when executed thereby, to perform or manage one or more aspects the project. These aspects may be, for example, any of scope, cost, quotes, and scheduling, communication, analytics, data visualization, tasks, workflow, calendaring, project participants, documents, and media, pertaining to the project. Accordingly, project management module 18 may include one or more directives, settings, rules, expressions, characteristics, parameters, commands and so forth.

Project management module 18 may include a number of modules which perform various functions. For example, project management module 18 may include any of a project module 60, project participants module 62, project place module 64, project calendar module 66, RFQ (Request for Quotes) module 68, media module 70, analytics and reporting module 72, communications module 74 and search module 76. Each of these modules 60 to 76, in general includes computer code including instructions executable by the server 14 or equivalent device, and may be independently loadable from long-term storage media (such as, but not limited to, a disk drive, CD-ROM, tape, or the like). Modules 60 to 76 may also include function, routines, subroutines, processes, dynamic link libraries (DLLs) and the like. In addition, any one of these modules 60 to 76 may include sub-modules for performing portions of the functions, routines, subroutines, and processes.

Project module 60 may include the functions of providing a summary of common project information to all project participants; providing the task information to project participants without having to recreate such task information; sharing common data; providing a scope describing the project; providing; identifying the members of a project team; providing basic project data; providing a project title and address; providing an owner name and address; providing descriptions and categories for a project; assigning unique identifiers to each project or sub-project and storing them in database 20. Generally, database 20 comprises a plurality of containers, such as container “place”, “sub-place”, and “project information element”, and includes files with different data types having data and associated metadata stored in the designated containers.

Project participants module 62 includes the functions of receiving and managing details of the project stakeholders, such as contractors, sub-contractors, project team, vendors, trades, and clients. Project participants module 62 also allows addition of a team member to a project; assigning unique identifiers to members of a project team; and defining project roles that may be shareable across the project.

Project place module 64 allows a user to define project locations; and manages location-centric information related to locations or sub-locations for which the project resources are bound, i.e. “places” and “sub-places”. For example, in a renovation project involving a remodelling of a bathroom, the bathroom is considered a “place” while a shower stall is considered a “sub-place” within the “place”. Project place module 64 also allows a user to define elevations for a building or structure; define the floors in a building or structure; and define rooms on a floor.

Project calendar module 66 manages project milestone dates, and allows users to identify major project milestones. For example, project calendar module 66 allows users to enter new milestone activities; identify schedule tasks; add a new schedule task; add a start date and an end date; calculate the schedule dates based on input of task data.

RFQ (Request for Quotes) module 68 manages RFQs, transmittals, submittals, additional items to scope, change orders and deficiency lists. RFQ module 68 also allows adding and listing of new RFQs; providing, to the project participants an indication or electronic notification of a RFQs due date and time; publishing RFQs; providing to the project participants, any of a summary and/or an overview of requirements, details describing the scope of services requested. RFQ module 68 may also provide quotes based on predetermined criteria and fee analysis, and allows a user to determine variances between estimated, actual and other costs.

Media module 70, allows uploading and cataloguing of documents, images and multimedia; providing linking of project specific data/information, for example, title, description, daily report, schedule, to a media objects, such as an image.

Analytics and reporting module 72 analyzes information related to the project and generates a variety of reports, such as, histograms, time lines, bar charts, and tabular data, and so forth, using data visualization techniques. Such reports may be useful in optimizing project execution and resource utilization, such as personnel, parts, inventory, equipment, tools, etc. Analytics and reporting module 72 can also provide forecasting based on resource constraints such as tools, inventory or manpower.

Communications module 74 allows exchange and sharing of notes, multimedia, documents, comments between the project stakeholders, in a collaborative fashion.

Search module 76 allows querying of data captured within the project management system 10.

A user, or project participant, can gain access to system 10 to create, access or manage any number of projects on that particular system 10. User-level security provides control over what individual users can create, access or manage within various parts of the system.

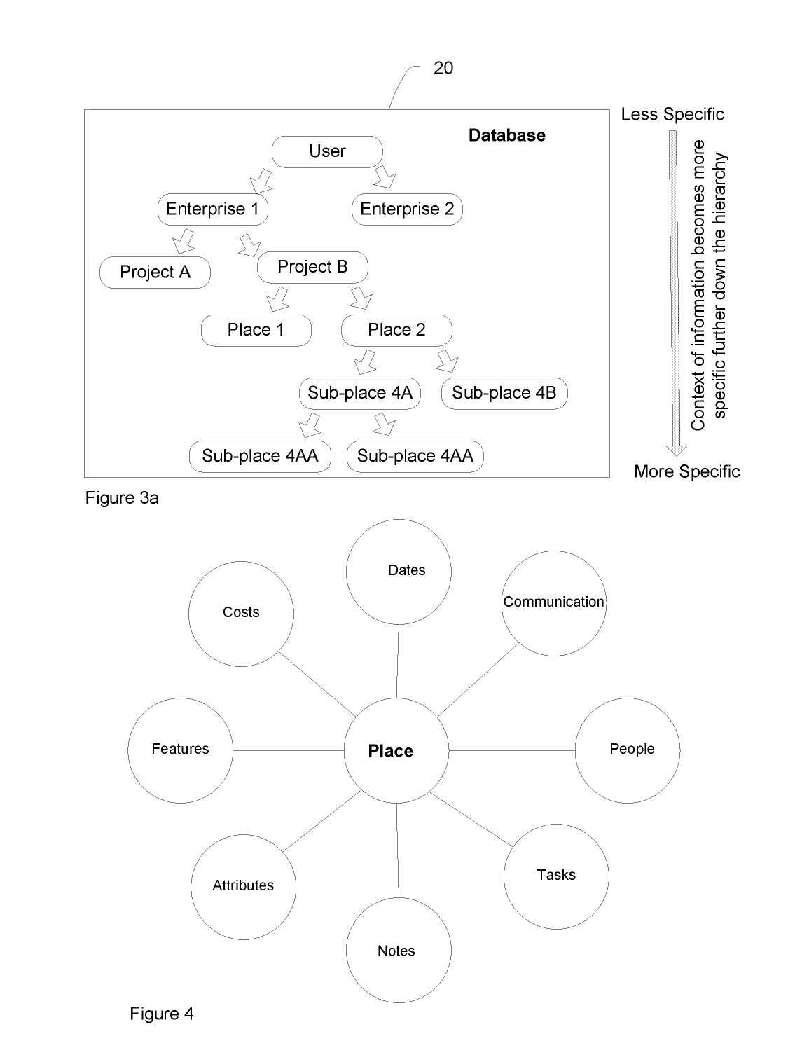

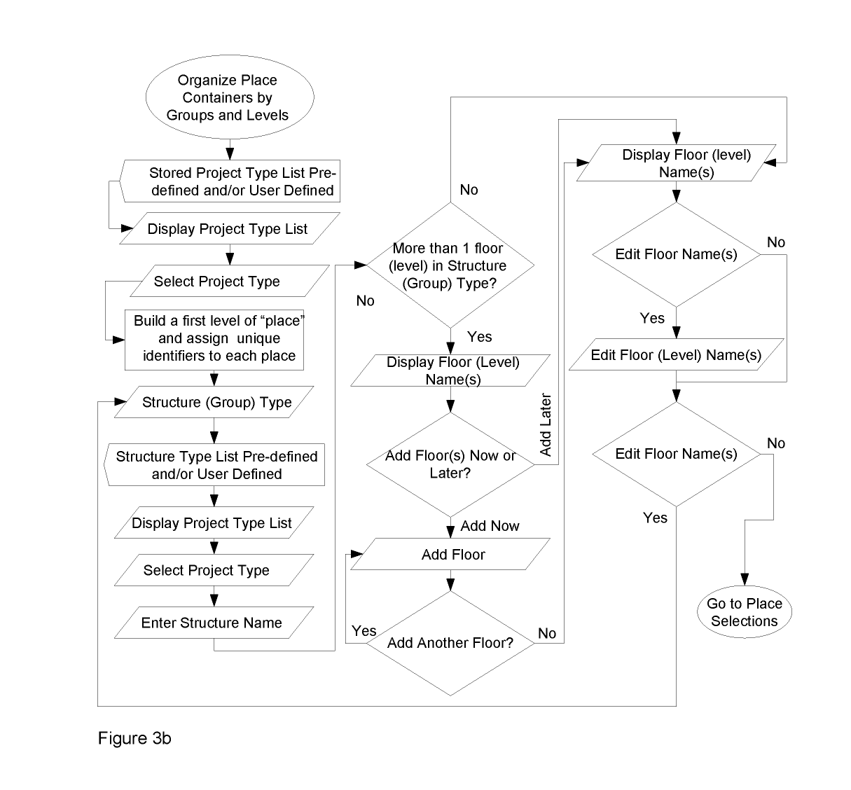

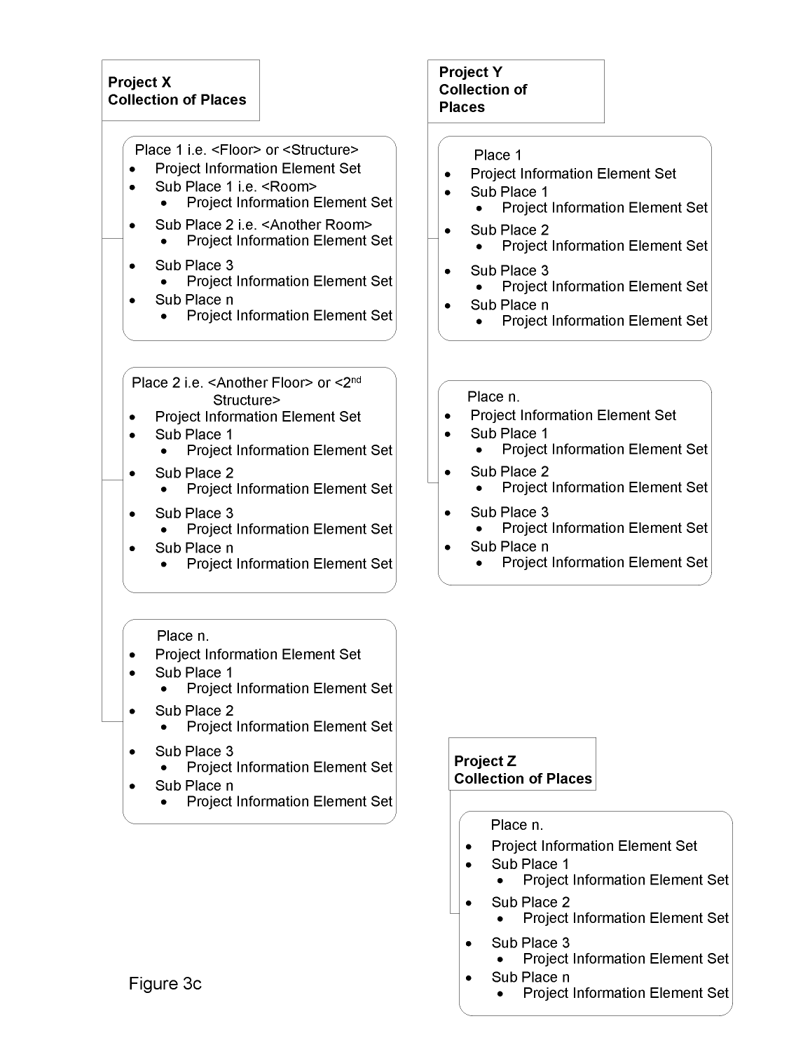

Each project is associated with a first level of places where tasks are to be performed, and the first level of places may include a second level of places or additional sub-places, and so forth, such that a project may comprise a plurality of levels of spaces (n levels), each level being uniquely identified, and including information or records specific to that level. Accordingly, the context of information regarding the project becomes more specific further down in the hierarchy from level 1 to level n. For instance, in the above example a user is able to drill-down to the minutiae of details about the project, such as the lighting plan for a family room, and may include the type of lighting (manufacturer, wattage, SKU, etc.), quantity of the light bulbs, cost, location for installation based on the dimensions of the family room (length, width, ceiling height), responsible team member for installation, scheduled install date, task duration, etc. FIG. 3a shows an exemplary embodiment of the database 20 having a location-centric hierarchical structure of information pertaining to the project.

Turning to FIG. 3b, there is shown a high level flow diagram illustrating exemplary process steps for building a place-centric hierarchical structure of information. FIG. 3c shows an exemplary embodiment of a database having a place-centric hierarchical structure of information pertaining to the project resulting from the process of FIG. 3b. Exemplary projects X, Y and Z, in FIG. 3c, include a collection of places, such that information that is captured is immediately or subsequently assigned or re-assigned according to a Place container [Place n] or any sub-container [Sub-Place n] or any feature set container [Project Information Element Set] inside a place or sub-place specific to the parent collection container [Project X, Y, Z etc.], i.e. place-centric assignment. In one example, a renovation project at a client's property (Ms. Smith) is assigned the moniker “Project Smith”, with work to be performed in the house (Place 1) i.e. structure, on the second floor (Sub-Place 1) and in the master bedroom (Sub-place 1a) and guest bathroom (Sub place 1b). The project also calls for work to be performed on another structure on Ms. Smith's property, a cabana (Place 2), and specifically to the roof (Sub-place 2a); and yet another structure garage (Place 3), requires work on the garage door (Sub-place 3a). Therefore, Project Smith includes a collection of places, which are structures: house; cabana and garage; and a plurality of sub-places related to those places slated to be worked on i.e. guest bathroom and master bedroom on the second floor of the house, the roof of the cabana and the door on the garage. In yet another example, a renovation project at a commercial building (ACME Corp.) is assigned the moniker “Project ACME”, with work to be performed on the ground floor (Place 1) i.e. place, in the warehouse (Sub-place 1a), and the cafeteria (Sub place 1b), and specifically to the cafeteria washroom (Sub place 1c). The project also calls to work to be performed on the 4^{th} floor (Place 2), and specifically to the north-east corner office (Sub-place 2a). Therefore, Project ACME includes a collection of places which are floors: ground floor and 4^{th} floor, and a plurality of sub-places related to those places slated to be worked on i.e. the warehouse and the cafeteria on the ground floor, and north-east corner office on the 4^{th} floor. The place centric assignment occurs in one or more positions in the user's workflow. The assignment of any information captured in any project information element can be edited or copied; or the data or information can be re-assigned automatically or manually with the relocation of the information once the information is captured within the program application. Alternatively, the information can be re-assigned automatically if the information is copied and pasted within the program application. Thus, the project place centric information elements keep their original identity in addition to a new identity such that the program maintains project information element place centric identity for the purpose of version control or audit trail queries.

As shown in FIG. 4, Place 78 is the hub through which multiple relationships are formed. Place-centricity affords information and data to be captured, organized, and interacted with in a workflow process to deliver novel non-obvious user capability and efficiency. Project information elements 79 each containing their specific information is or can be in the future linked through a common relationship i.e. Place 78. Any one project element 79 or any combination of elements 79 as they relate to Place 78 yields new opportunities for information management, understanding and interaction. The terms “project information element” and “project element”; and the terms “space” and “place” will be used interchangeably throughout the specification.

Place 78 is an object container around which typical project information elements 79, such as time; notes; images; multimedia; costs; dates; meetings; tasks; communication, and people revolve. Accordingly, project information can be captured, organized, and interacted with in a new way and afford users unique experiences to exercise their capabilities and increase productivity when managing project information. This enhances user workflows and contributes to improved efficiency and cost reduction through time spent capturing, storing, filing, managing, communicating, compiling, searching, sending, receiving, researching, and accuracy of information management.

Place-centricity offers a plurality of benefits, such as immediate and relevant connection with project information elements 79 based on Place 78. Day to day activities revolve around Place 78 and with place-centric project management so too can project information.

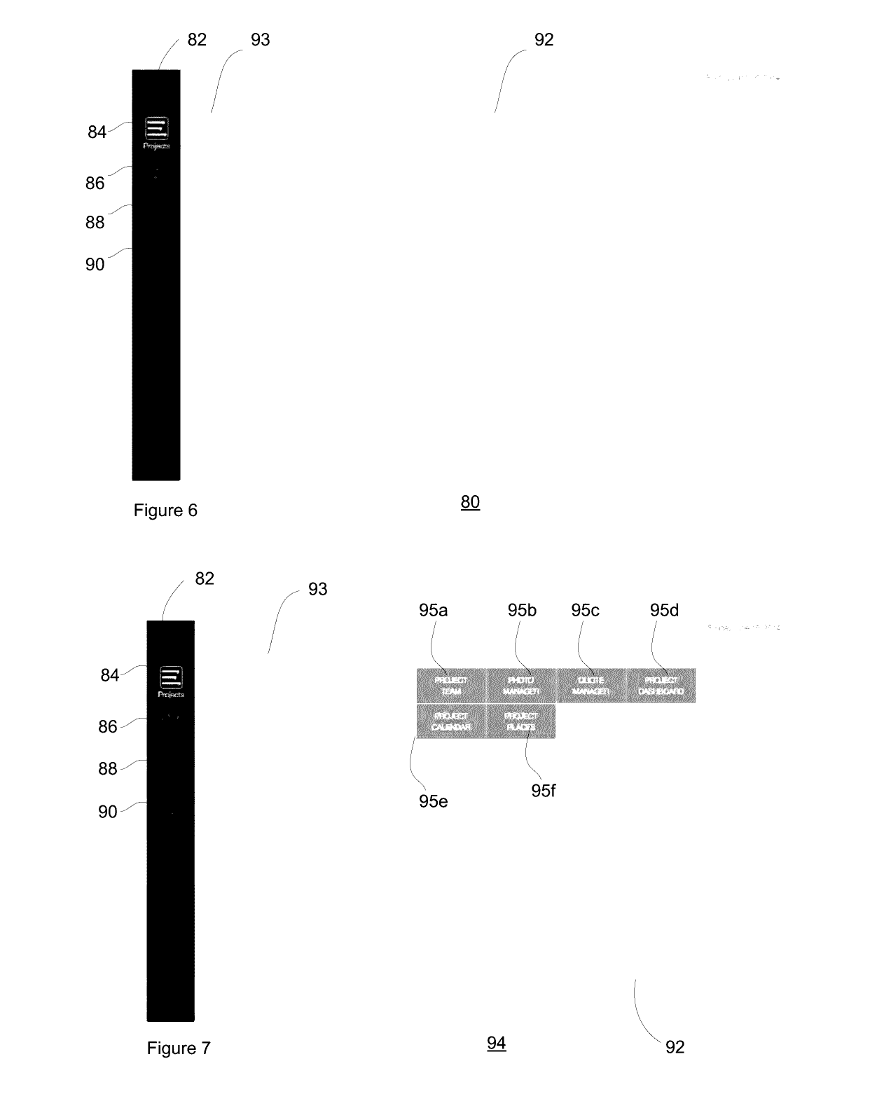

In one exemplary embodiment, FIG. 5 shows exemplary process steps for building a place-centric hierarchical structure of information pertaining to a renovation project. A hierarchical relationship is established between place-centric projects within system 10 comprising an overall project wherein the overall project has a parent/child relationship to places and sub-places. Following a user login and authentication process (step 300), the user is presented with an exemplary first graphical user interface (GUI) 80, as depicted in exemplary screenshot of FIG. 6. First GUI 80 includes one portion 82 with a plurality of GUI objects, such as buttons or icons 84, 86, 88 and 90 for navigating the system 10, a second portion 92 and an intermediate portion 93. For example, button 84 is associated with projects available on a particular system 10, and allows creation, edition, and deletion of projects, as will be described below with reference to FIG. 3a. Button 86 is associated with stakeholders of projects within the enterprise, and provides access all stakeholders, such as employees, contractors, sub-contractors, vendors, suppliers, trades, companies, clients, and others within the system 10. Given proper access permissions, any one of the stakeholders may access and view information pertaining to the place or sub-places, such as review changes or variances made to project scope and schedules, or edit the project scope and schedules. Button 88 provides access to shared, enterprise calendars, such as a resource calendar, task calendar, project calendar, and corporate calendar. Button 90 allows a user to perform queries on data captured within the system 10 and stored in database 20. Accordingly, buttons or icons 84, 86, 88 and 90 provide access to enterprise project information pertaining to, but not limited to, people or team participating on a project, photos, documents, media, quotes, RFQs, metrics, analytics, data visualization, calendar, tasks, workflow, places, and sub-places.

Turning now to FIG. 7, there is shown an exemplary second GUI 94, with second portion 92 displaying content related to buttons or icons 84, 86, 88 and 90. In this example, button 84 labelled “Projects” is selected and various buttons 95a to 95e representing different ways to navigate information within a selected project are displayed in portion 92. For example, button 95a is labelled “PROJECT TEAM” and when selected, button 95a causes participants module 62 to perform functions related to stakeholders, as described above. Correspondingly, button 95b labelled “PHOTO MANAGER” is linked to media module 70; button 95c labelled “QUOTE MANAGER” is linked to RFQ module 68; button 95d labelled “PROJECT DASHBOARD” is linked to project module 60 and analytics and reporting module 72; button 95e labelled “PROJECT CALENDAR” is linked to project calendar module 66 and button 95f labelled “PROJECT PLACES” is linked to project place module 64; and selection of any of these buttons 95a to 95f causes the respective linked module to perform its set functions as described above. In any project, information in each ‘place’ can be accessed by navigating to that place, or alternatively by navigating to the information type and managing which places the information is relevant to.

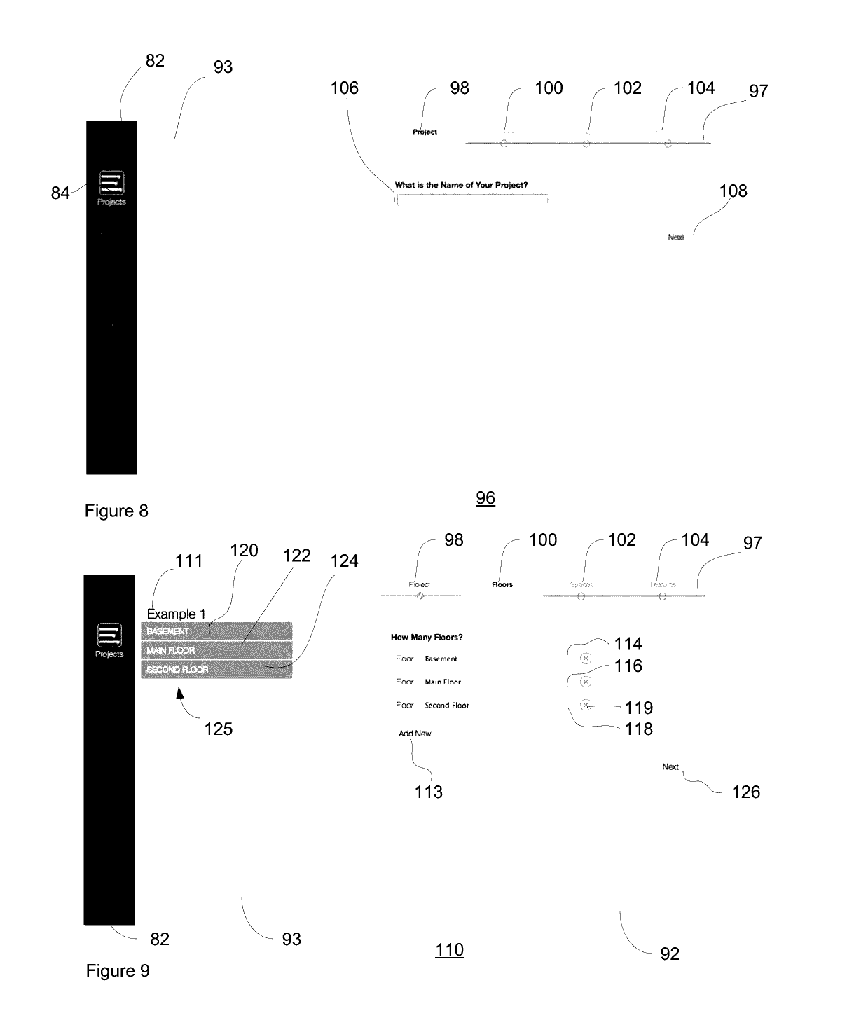

In one example, in order to start building a place-centric hierarchical structure of information pertaining to a renovation or building or construction project, button 95d is actuated, and the user is provided with an option to create a new project and an option to select a previously created project (step 302). When the election to start a new project is made, then a new project build begins (step 304), otherwise when one of the existing projects is selected (step 306), the process moves on to step 310, as will be described below. As shown in exemplary screenshot of FIG. 8, an exemplary GUI 96 comprises a progress bar 97 is disposed within portion 92, and includes a project icon 98, floors icon 100, spaces icon 102 and features icon 104. Project icon 98 is highlighted to indicate in-progress input activity related thereto, while other icons 100, 102 and 104 are grayed out to show inactivity or that input fields related thereto have yet to be populated. An input field 106 receives a name for the new project from the user. Inputting the project name and selecting next icon 108 causes search module 76 to query database 20 to determine whether the inputted project name, such as “Example 1” is associated with any other enterprise projects. If there is a match, then an appropriate error message is posted instructing the user to choose another name, otherwise “Example 1” is assigned a unique project identifier by the project module 60 (step 308), and the unique project identifier is stored in database 20 to form part of the eventual comprehensive data for analytics and report creation. Step 308 may also include sub-steps of entering details pertaining to a client, start date, completion date, milestones, deliverables, and other basic project information. Accordingly, this project-level information is useful for reference, generation of meta-data, and organization.

In next step 310, third GUI 110 is presented, and thereon a user may build a first level of ‘place’ which will be used to organize and subdivide all project information by the place to which it pertains. As shown in exemplary screenshot of FIG. 9, project icon 98 on progress bar 97 is now associated with indicia, such as color or a checkmark to indicate successful completion of the previous step 302. Floors icon 100 is now highlighted to indicate in-progress input activity related thereto, while icons 102 and 104 are still grayed out. The name of project 111 i.e. “Example 1” is displayed in third portion 93 intermediate first portion 82 and second portion 92. A user is able to add a number of floors of the house or building structure by selecting “Add new” button 113, and each floor type may be specified, such as basement, first floor and second floor using drop-down menus 114, 116 and 118. Floors may be deleted by selecting a “delete” icon 119 adjacent to each of the drop down menus 114, 116 and 118. Each of the floors is assigned a unique space identifier by the project module 60, and the unique space identifiers are stored in database 20. As the floors are added, they also appear below project name 111 as hyperlinked floor buttons 120, 122 and 124, and so forth, to form floor button panel 125. It should be noted that various types of visually-cued ‘hyperlinked’ GUI objects can be employed, and can include underlined, highlighted, and/or colored text, images or regions within images, etc.) operable by a pointing device via input events such as clicking when the screen cursor is overlaid or sufficiently close to the spatial location of the visual cue. To advance to the next step 312, “Next” button 126 is selected.

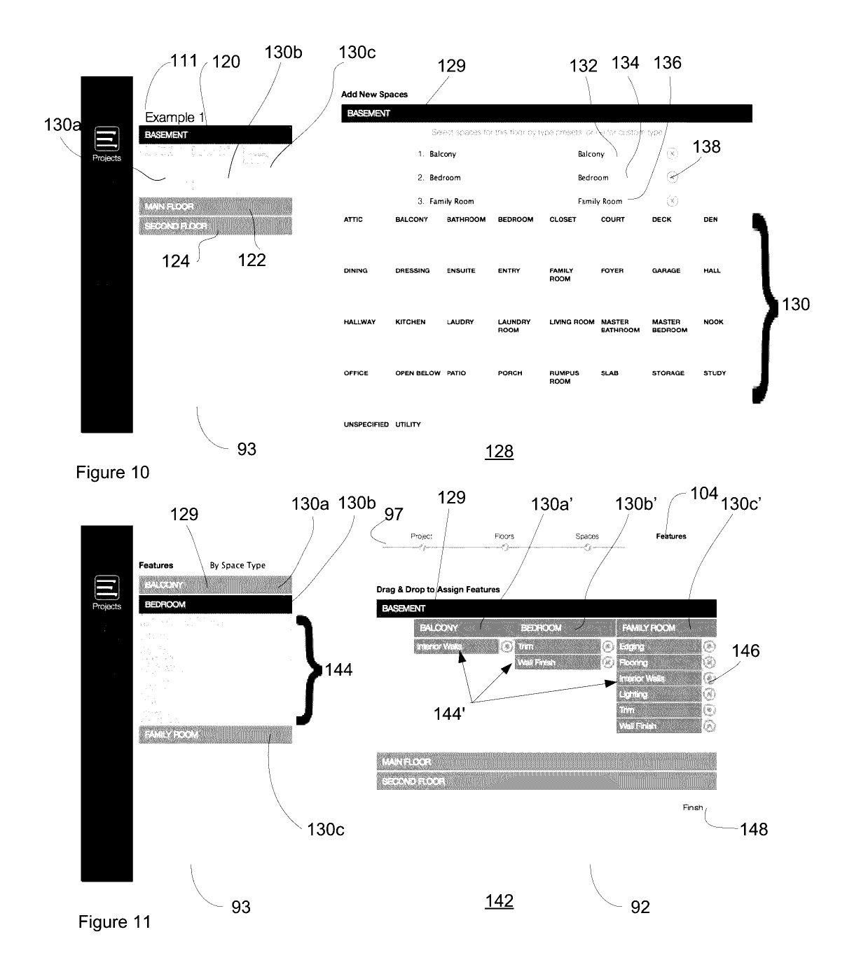

In the next step 312, following actuation of button 126, a fourth GUI 128 is presented, on which a user may build a second level of ‘places’ within each of the first level of places i.e. floor type, to build out a hierarchical place-based structure used to capture and display information. As shown in exemplary screenshot of FIG. 10, project icon 98 and floors icon 100 on progress bar 97 are now associated with indicia, such as color or a checkmark to indicate successful completion of the previous steps 304 and 310, while spaces icon 102 is highlighted to indicate in-progress input activity related thereto, icon 104 is still grayed out (not shown). A user is able to add spaces to the predefined number of floors of the house or building structure. For example, in FIG. 10, when “BASEMENT” floor is selected from the intermediate portion 93, then floor title 129 “BASEMENT” is displayed in second portion 92, and a plurality of space choices 130 appear below floor title 129. Spaces 130 may be dragged and dropped onto the desired onto the desired room on buttons 120, 122 and 124. The space choices may include any of an attic, balcony bathroom, closet, court, deck, den, dining room, dressing, en suite, entry, family room, foyer, garage, hall, hallway, kitchen, laundry, laundry room, living room, master bathroom, master bedroom, nook, office, open below, patio, porch, rumpus room, slab, storage, study, utility and custom space. As spaces 130 are added, such as “BALCONY” 130a, “BEDROOM” 130b and “FAMILY ROOM” 130c, they appear below button 120 corresponding to the “BASEMENT” floor. Correspondingly, if spaces 130 are added to the “MAIN FLOOR” 122, then the desired spaces 130 would appear below button 122, and so forth. In portion 92, drop-down menus 132, 134 and 136 allow the user to select a preset space type, and enter a customized description of the floor in input fields 137a, 137b and 137c. Any of these spaces may be deleted by selecting “delete” icon 138 adjacent to each of the drop down menus 132, 134, 136. Each of the spaces are assigned a unique space identifier by the project module 60, and the unique space identifiers are associated with the unique place identifier and the unique project identifier, and stored in database 20. To advance to the next step 314, “Next” button 140 is selected.

In the next step 314, following actuation of button 140, fifth GUI 142 is presented, and thereon a user may add features to desired space 130 of basement room associated with button 120, 122 or 124. As shown in exemplary screenshot of FIG. 11, project icon 98, floors icon 100 and spaces icon 102 on progress bar 97 are now associated with indicia, such as color or a checkmark to indicate successful completion of the previous steps 302, 304, 306 while features icon 104 is highlighted to indicate in-progress input activity related thereto. A user is able to add features 144 to spaces 130 by assigning items, objects, information, communications, people, times, work, tasks, media, or other data. For example, in FIG. 10, when “BASEMENT” floor button 120 is selected from the intermediate portion 93, then “BASEMENT” floor label 129 is displayed in second portion 92. In intermediate portion 93, a space type of the “BASEMENT” may be selected using drop-down menu 146 to choose between “BALCONY” 130a, “BEDROOM” 130b and “FAMILY ROOM” 130c. For example, features 144 available for “BEDROOM” 130b may include AV/home entertainment, edging, flooring, interior walls, lighting, trim and wall finish. Any of these features 144 appearing in intermediate portion 93 may be added by dragged and dropped to the desired space “BALCONY” 130a′, “BEDROOM” 130b′ and “FAMILY ROOM” 130c′ appearing in second portion 92, such that identical features 144′ appear below the desired space 130a′, 130b′ or 130c′. Each of the added features 144′ appearing in second portion 92 are associated with a “delete” icon 146 to allow deletion of a feature 144′. The assignment may be performed individually or as a group. Each of the features are assigned a unique feature identifier by project module 60, and the unique feature identifiers are associated with the unique space identifier, unique place identifier and the unique project identifier, to form a place-centric hierarchical data structure, which is stored in database 20. When the features 144 have been added, a “Finish” button 148 is selected, and process ends.

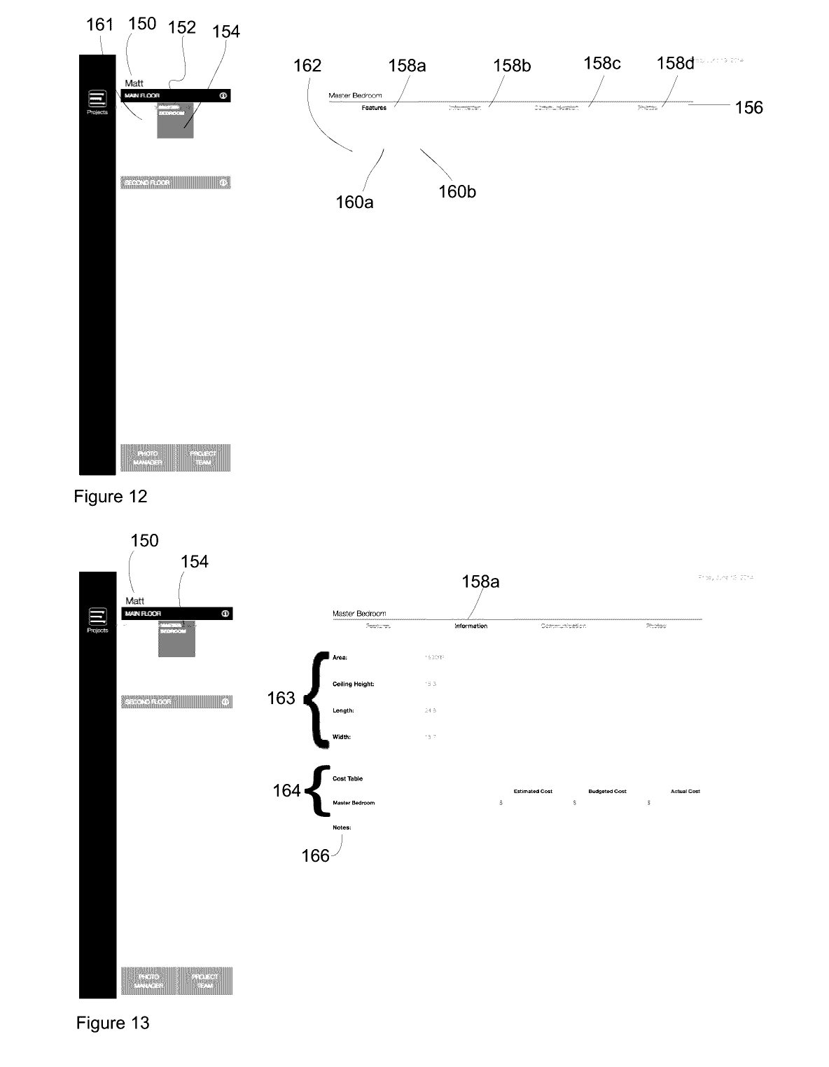

Now turning to FIG. 12, there is shown an exemplary screenshot depicting information captured and displayed, such as, features and selections associated with a first level of place, containing sub-places in clickable accordion 149. Sub-places, contained by accordions representing the first level of places within the project. Each sub-place is clickable to reveal information that pertains to that place specifically. Accordingly, a container ‘Place’ within database 20 comprises data types such as, but not limited to objects, features, metrics, descriptive information, people, times, work, tasks, communications, notes, media. For example, in FIG. 12, there is shown a project identified as “MATT” 150 in intermediate portion 93 with a floor associated with “MAIN FLOOR” button 152 with a master bedroom sub-place associated with “MASTER BEDROOM” button 154. A type navigation bar 156 associated with the master bedroom is displayed in second portion 92, and includes data types represented by features button 158a, information button 158b, communications button 158c and photos button 158d. In this example, selecting features button 148 causes the display of the following features: “BACKSPLASH” 160a and “CARPENTRY” 160b in second portion 92. Additional sub-places to the main floor may be added by selecting an “add” tile 161 in accordion 149. Correspondingly, additional features to master bedroom associated with sub-place “MASTER BEDROOM” 154 may be added selecting an “add” tile 162 in portion 92.

In FIG. 13, there is shown another exemplary screenshot depicting various metrics and descriptive data captured and displayed as they pertain to a place, such as a master bedroom. For example, selecting the information button 158b displays various metrics corresponding to the master bedroom, such as, dimensions 163 of the master bedroom such as area, ceiling height, length and width; including a cost table 164 for the master bedroom, such as estimated cost, budgeted cost and actual cost, as well as notes 166.

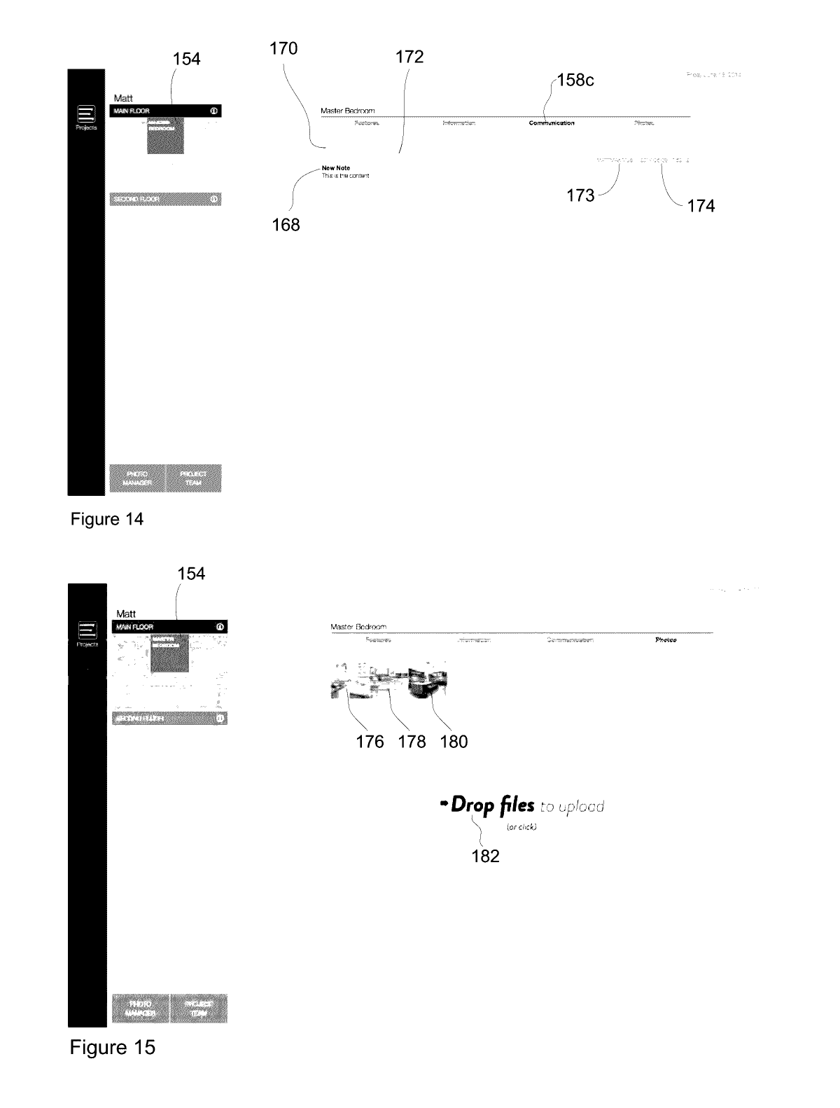

In FIG. 14, there is shown yet another exemplary screenshot depicting communications, photos and notes, captured and displayed as they pertain to a place, such as a master bedroom. When communications button 158c is selected, all communications related to the master bedroom place are displayed in portion 92. Notes 168 may be added by selecting “add” icon 170 on task bar 172 and include originator 173 of note 168 and an automatic date stamp 174 pertaining to note 168. When note 168 is posted, an alert is sent to all stakeholders for which that note 168 has relevance.

At any point in a user's workflow the notes input function can be executed to capture notes, therefore the function may be executed anywhere in the program application and at any level of place (project level/floor level/place level/sub-place/place feature/place page views). Accordingly, notes are captured in the place where the user executes the notes function, such that the notes are automatically assigned to the place in which the program executes the notes input function. Notes can be reassigned or copied to other places. In one example, a red button, or other indicia, is employed to signify a note capture mode in the program application. When executed, a notes window is launched and overlays the active window during mid-workflow, as the need to capture notes in a project can arise at any time for the user. The notes window minimizes distraction to the user and allows the interruptive process of notes capture to occur and then allow the user to get back to their previous task or state of workflow. The note assignment is by default auto-populated from the space in which the notes window is opened, this assignment option is firstly auto-populated and can then be editable or re-assignable by selection from a list once the relationship is populated or established. The notes can be filtered, stored, referenced, accessed, served in a database, viewed, reported on, or edited by one or more users by place-centric assignment.

In FIG. 15, there is shown an exemplary screenshot depicting photos and media uploaded/captured and displayed as it pertains to a place, such as a master bedroom. For example, when photos button 158c is selected, photos related to the master bedroom place is displayed in portion 92, such as photos 176, 178, 180. Additional images may be added by selecting an “Upload” icon 182.

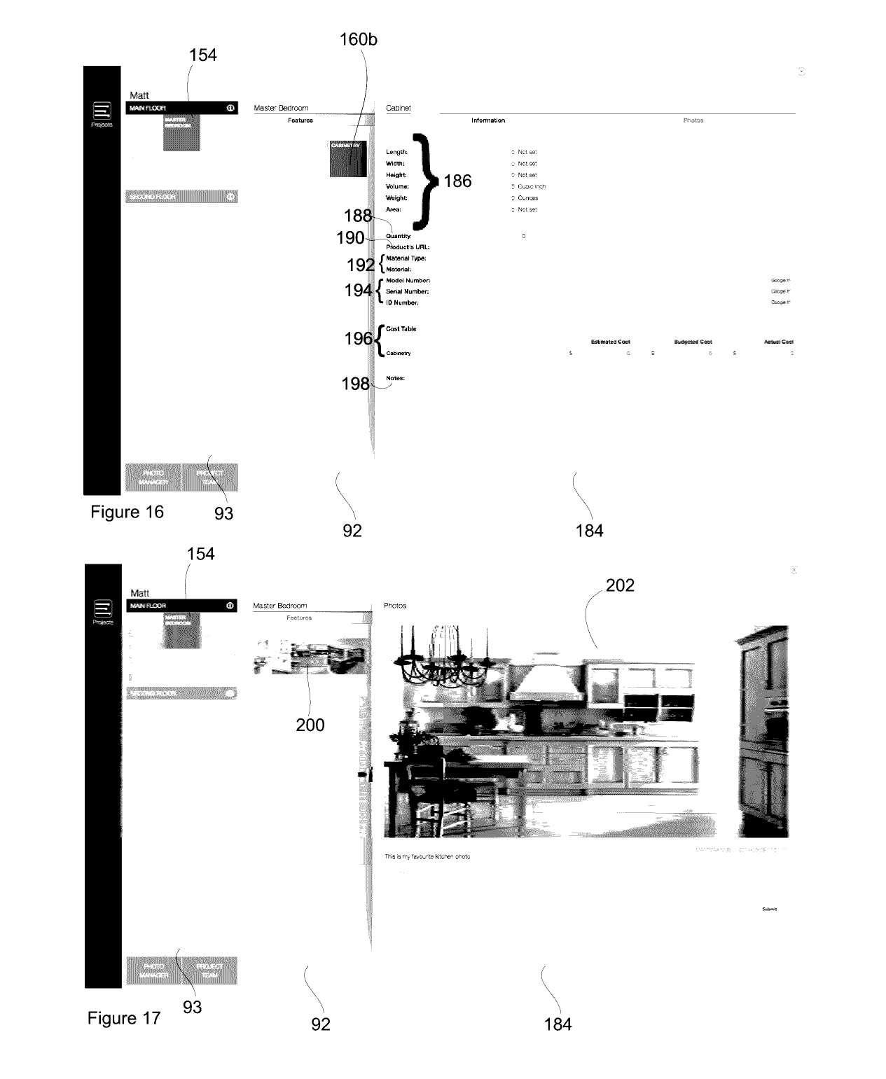

In FIG. 16, there is shown an exemplary screenshot depicting information overlays revealing more information within a place, such as a master bedroom, such that a second portion 184 (now reduced in size) shows features “BACKSPLASH” 160a and “CARPENTRY” 160b. When features tile “CARPENTRY” 160b is selected from the second portion 92 in FIG. 11, then more detailed information pertaining to the carpentry is displayed in a sub-portion 184 of second portion 92, via a sliding motion. The detailed information may include dimensions 186, such as, length, width, volume, weight, area; quantity 188, product URL 190, material characteristics 192, product identification information 194, such as model number, serial number and ID number, and cost table 196 for the carpentry, such as estimated cost, budgeted cost and actual cost, as well as notes 198.

In FIG. 17, there is shown an exemplary screenshot depicting information overlays revealing more information within a place, such as a master bedroom, such that photos, documents, other media added in FIG. 13 may be selected in the second portion 92 and previewed or displayed in an enlarged format in sub-portion 184. For example, image 200 of cabinetry is selected in second intermediate portion 184 and a corresponding enlarged version 202 is displayed in second portion 92.

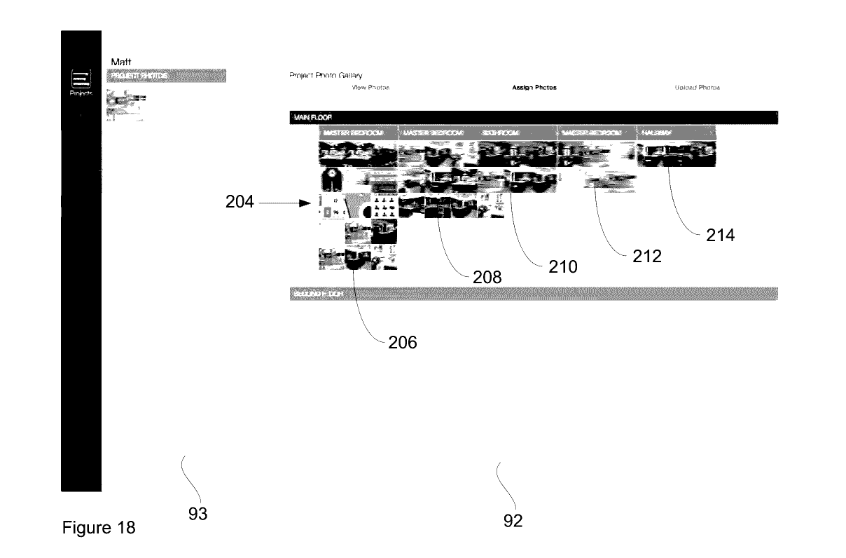

In FIG. 18, there is shown an exemplary screenshot depicting information pertaining to the project “Matt” 150 in which objects, such as communications, notes, media, data to each ‘Place’ may be assigned by dragging dropping the objects from the intermediate portion 93 to the appropriate place in the second portion 92, allowing for quick and easy assignments and all data captured and organized in terms of the place. Objects, such as, information, communications, people, times, work, tasks, notes, media, and other data in left pane can be dragged & dropped into containers for each place, such as spaces on a main floor. For example, FIG. 17 shows a photographic image gallery 204 with photographic images (“photos”) 206 associated with a first master bedroom, photos 208 associated with a master bedroom, photos 210 associated with a bathroom, photos 212 associated with a second master bedroom and photos 214 associated with a hallway.

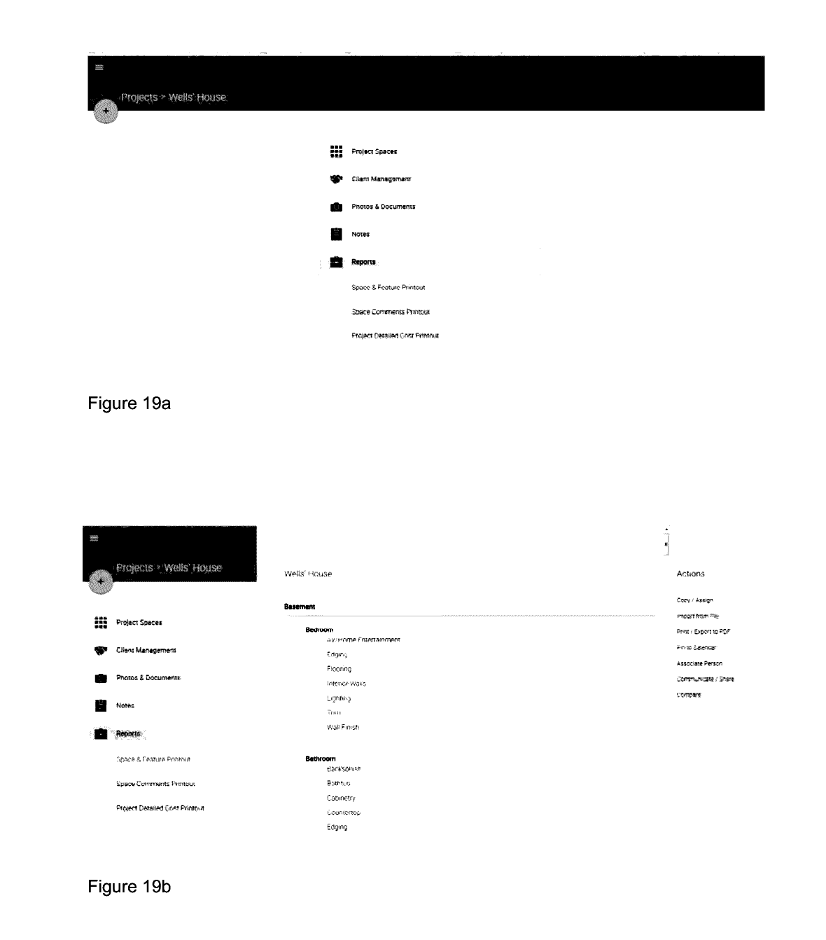

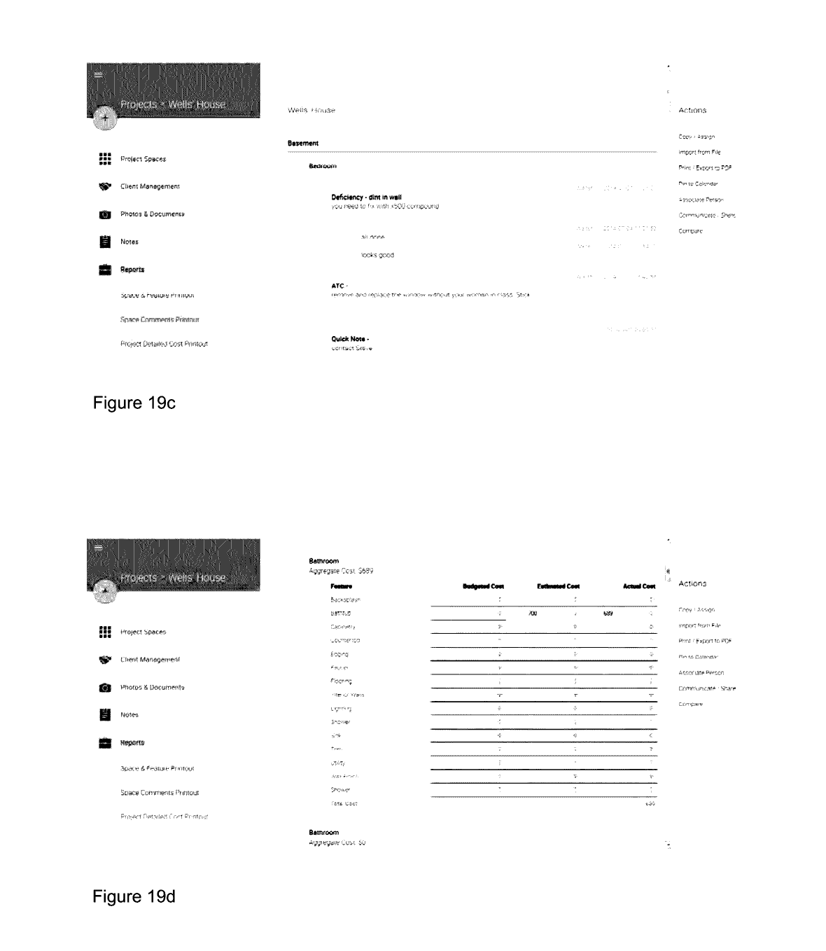

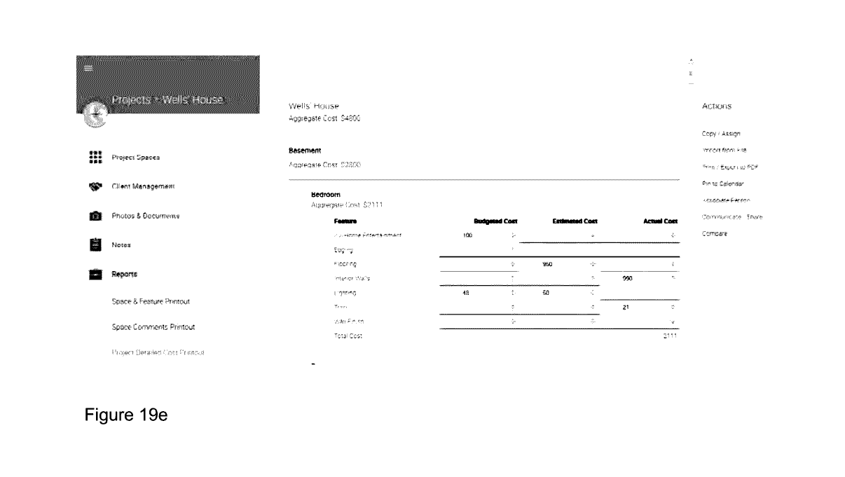

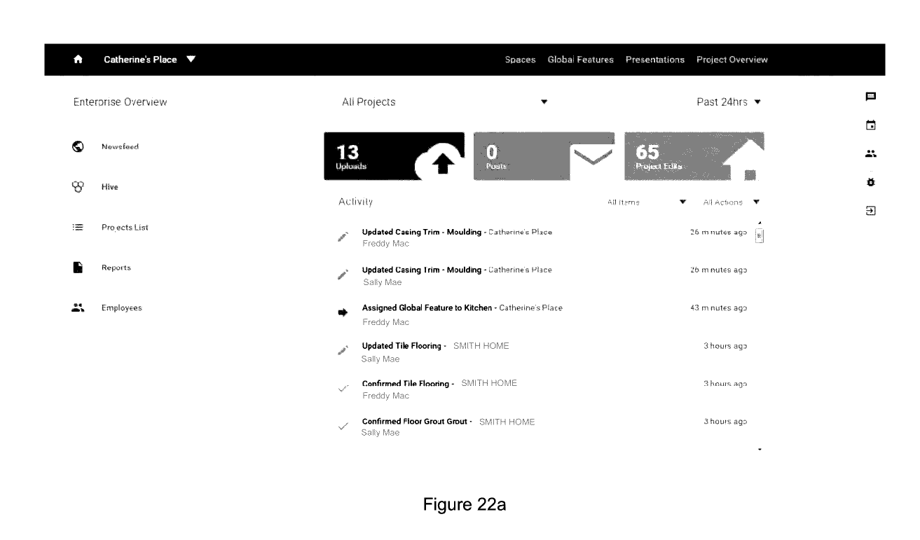

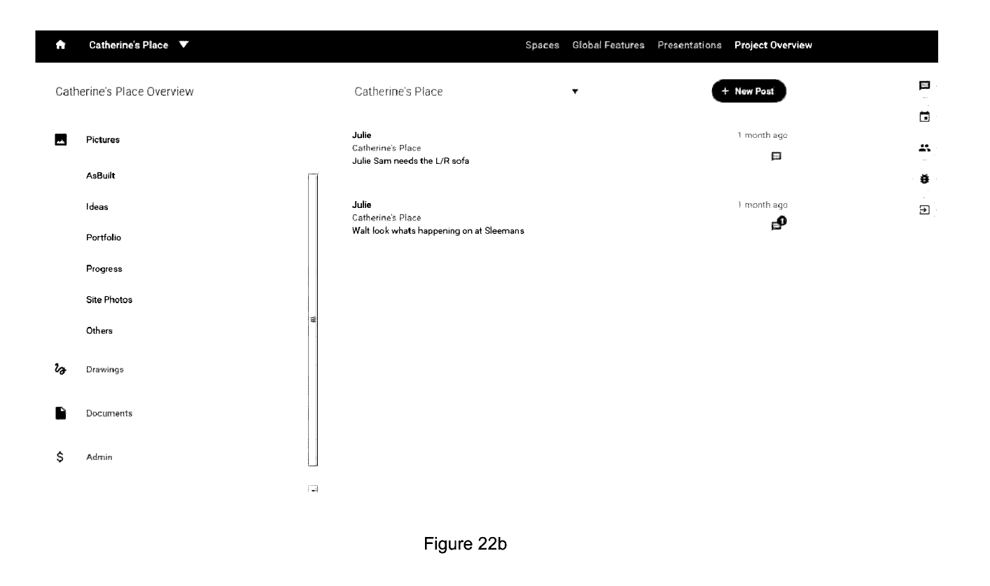

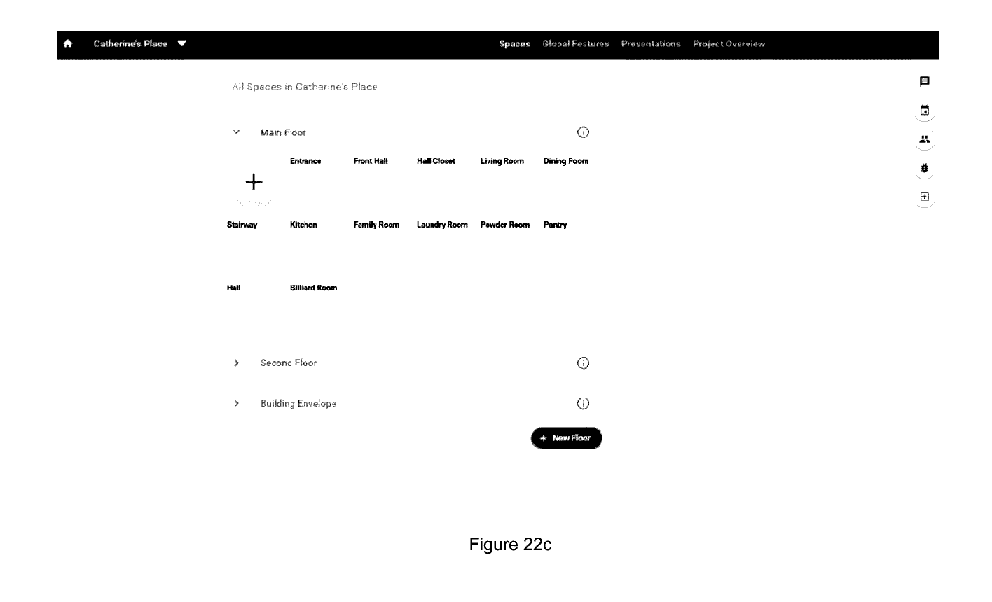

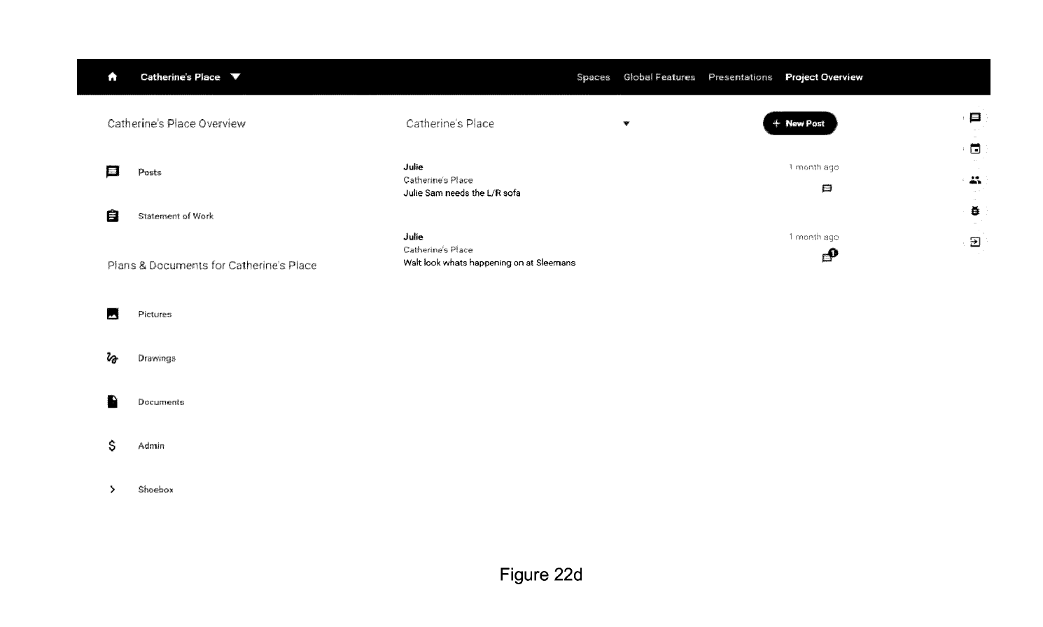

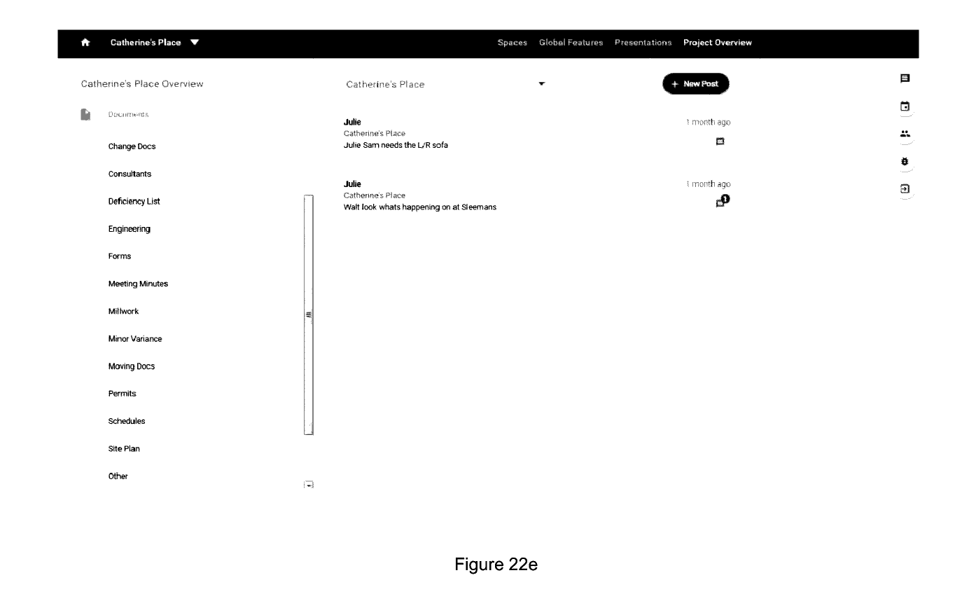

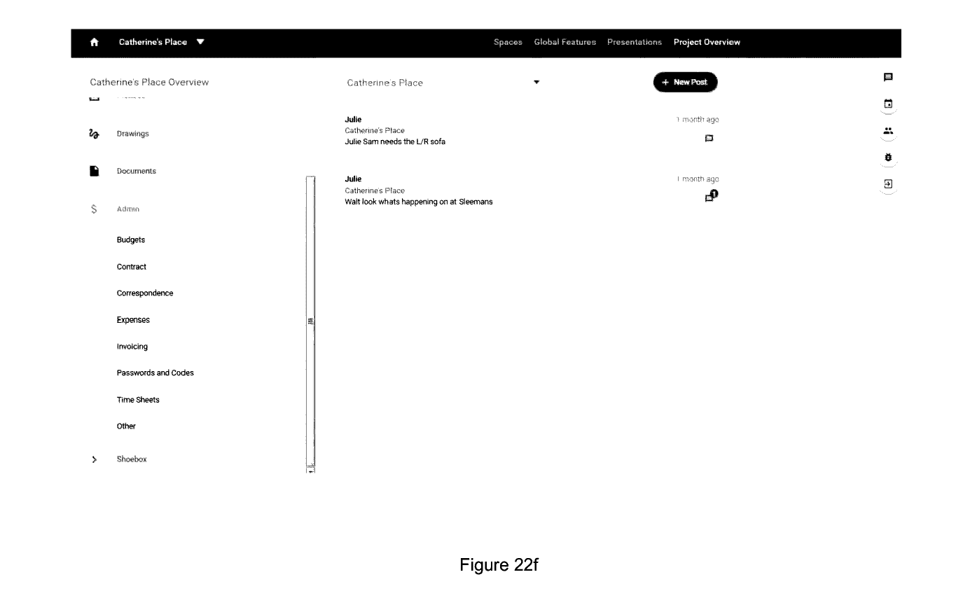

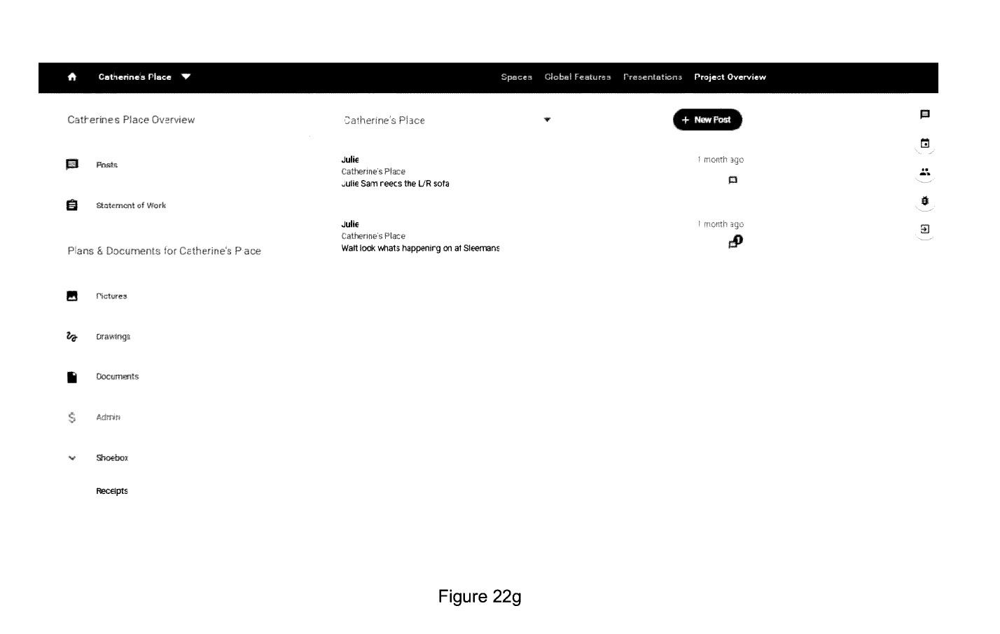

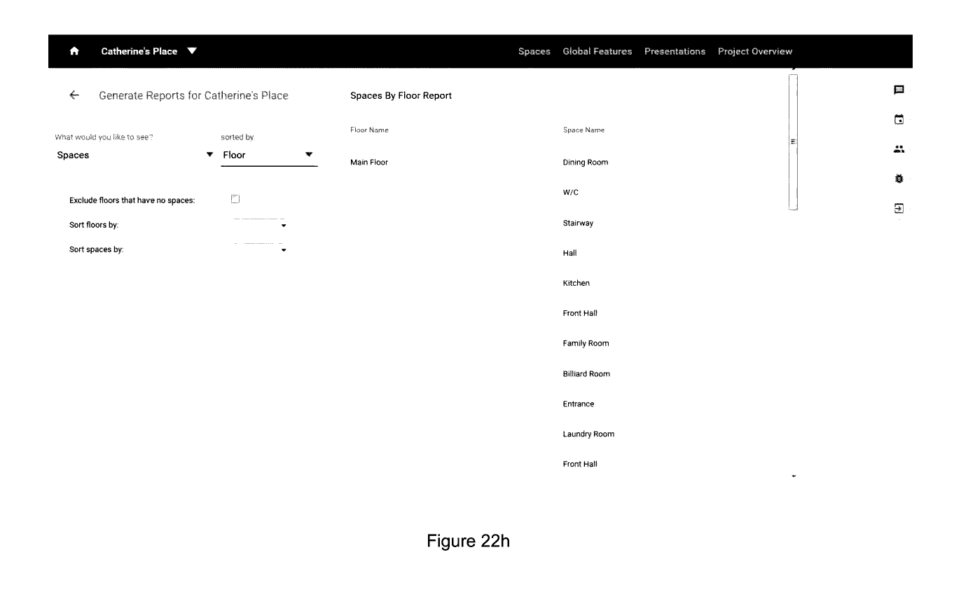

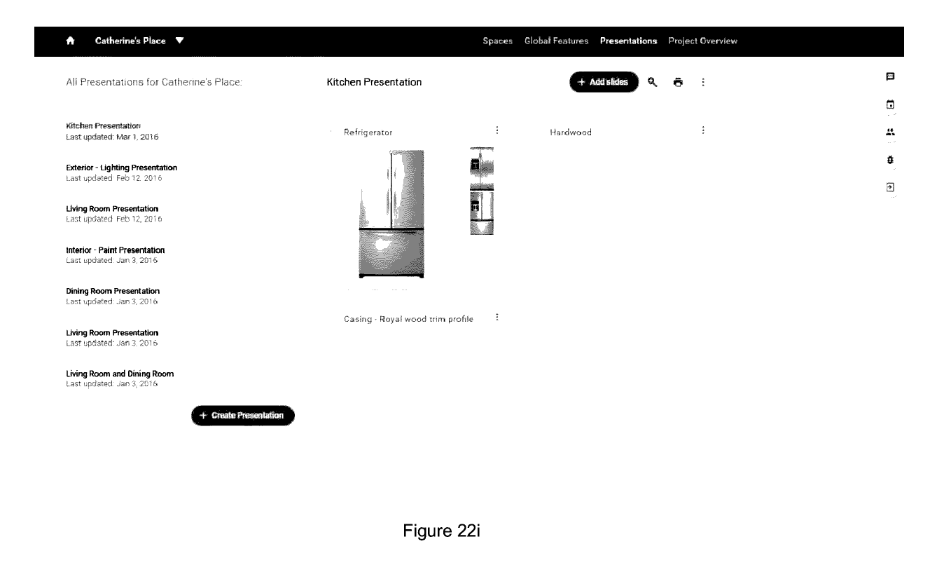

Looking at FIGS. 19a to 19e, and 22h there is shown a plethora of reports related to a place that can be provided. For example, with 8 peripheral project information elements 79 related to Place 78, there are 256 combinations of reports plus one report with place only without any elements 79. Exemplary reports include: Dates and People about a Place; Costs and People about a Place; Tasks and people about a Place; Features and people about a Place; Attributes and people about a Place; Communications and people about a Place; Notes and people about a Place.

Other exemplary reports include: Dates and Costs about a Place; Tasks and Costs about a Place; features and Costs about a Place; attributes and Costs about a Place; communications and Costs about a Place; notes and Costs about a Place.

Yet other exemplary reports include: Dates and Tasks about a Place; Features and Tasks about a Place; Attributes and Tasks about a Place; Communications and Tasks about a Place; Notes and Tasks about a Place.

Yet other exemplary reports include: Features and Communications about a Place; Attributes and Communications about a Place; Dates and Communications about a Place; Notes and Communications about a Place; Features photos and notes about a Place; Attributes photos and notes about a Place; Dates photos and notes about a Place; Features, Notes, and People about a Place; Attributes, Notes, and People about a Place.

Therefore, place-centric project information becomes increasingly useful as the individual project information element 79 components (information or data that comprise each element) receive status and priority markers or values such that a “Place” 78 can have due dates, reminders, groups, and warnings/alarms applied that trigger or report on a plurality of criteria, much like calendar reminders or tasks in typical project management systems that use time, task, people, costs or dates as their centricity and ignore “Place” 78.

In one example, a construction manager is able to determine the trades people who are scheduled to arrive at a project site and perform work in a bathroom renovation as opposed to the kitchen for a given date. A report listing the trades people (Project information element) and their scheduled date for the bathroom (Place) is generated. Similarly, the manager may choose to view the same criteria only using a different Place i.e. Kitchen instead of Bathroom which yields a new list generated. In fact, the manager can look across all Projects to see the same type of report i.e. determine trades that are scheduled to arrive on a given date for all Kitchens or Bathrooms.

A plurality of queries is possible, and yield associated detailed reports. Exemplary queries include: “All Kitchens and Bathrooms with Granite Counter Tops more than $2000”; “All Rooms with Extras on the second floor”; or “All Bedrooms with Deficiency Notes”. User inputs project element information in a natural way during a workflow into a Place Container whereto the information relates. The project element information is classified and automatically assigned to the Place in which it has been input by the user. The project element information or data input in the place can be served up in a multitude of useful way i.e. reports, views, management, or reference all within the structure of one application without having to compile the information or data from other free-form software applications. Place centricity affords project element information to share a common relationship.

Electronic message corresponding to a project may be initiated, compiled, and exchanged between stake holders according to exemplary method steps comprising: initializing a window on a graphical user interface to include a place object associated with a location of said project; responsive to user selection of the place object, displaying an object attributes window including at least one project element type associated with the place object and a plurality of selectable attributes associated with said at least one project element type; responsive to user selection of one or more attributes, associating selected attributes with the place object and the at least one project element type; initializing an editable free-form user interface element, and populating the free-form user interface element with the place object, the at least one project element type and associated the plurality of selectable attributes. The electronic message comprises said place object is an originator of message, and at least one of the selectable attributes form a subject of the electronic message, and the free-form content forms a body of said message; and the electronic message pertains to one of the place object and at least one of the selectable attributes, and one of the place object and at least one of the selectable attributes and contribute to a communication method, such that communication between users is place-centric rather than user-centric.

In one example, suppose that a stakeholder of Project ACME desires to send a message related to the cafeteria washroom (Sub place 1c), then the originator of the message would be “PROJECT ACME-Ground Floor-Cafeteria-Washroom”. The body of the message would include some descriptive text pertaining to the topics related to the cafeteria washroom, such as any attributes (characteristics of a place) e.g. metrics (height, length, width) pertaining to the place and portals (openings that lead to other space containers such as structures, floors, places and sub-places) e.g. windows, doors, stairways/elevator ways of the cafeteria washroom itself, and/or including but not limited to the: area of the walls; area of the floors; area of the ceiling; thickness of wall(s)/floor(s)/ceiling(s)/structure(s); or any feature (objects within a place), such as floor tile, stalls, sinks, and their respective features or attributes. Also included in the body may be thumbnail views of the floor tiles, stalls or sinks, and these thumbnail views may be actuated by a pointing device to launch a page view of the floor tile, stall or sink, similar to the page view of FIG. 17. On that page view, notes may be entered by stakeholders, and these notes are assigned a time-stamp, and include the stakeholder responsible for the notes, and IP address of the stakeholder's device, among others, for an audit trail. In another example, suppose the stakeholder desires to send a message related to the cafeteria warehouse (Sub place 1a), and the cafeteria (Sub place 1b) then the originator might be “PROJECT ACME-Warehouse+Cafeteria”, such that the message may originate from one or more places and/or one or more sub-places, as desired.

In yet another embodiment, full audit trails are generated for all transactions to analyze irregularities or any detail of interest, or for security purposes.

In another embodiment, the method and system as described may be useful for managing projects related to construction, renovation, remodeling, interior design; construction; architecture, engineering, commercial, manufacturing, institutional, government, healthcare, education, law enforcement, military, event planning, movie entertainment and production, consumer and travel industries.

In another embodiment, other modules pertaining to billing, accounting, and purchase orders may be included.

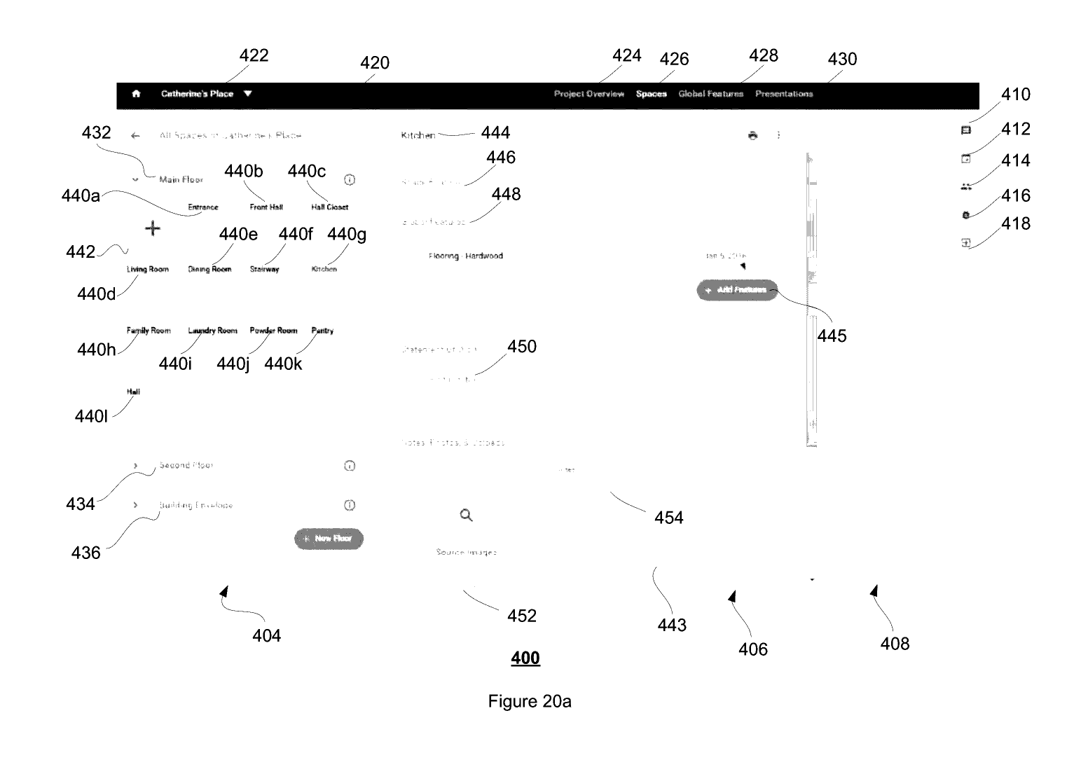

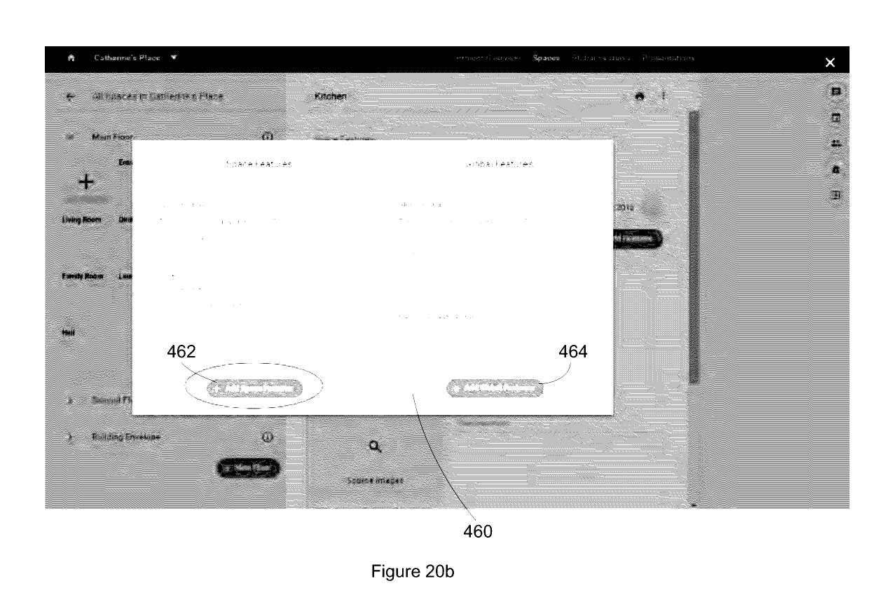

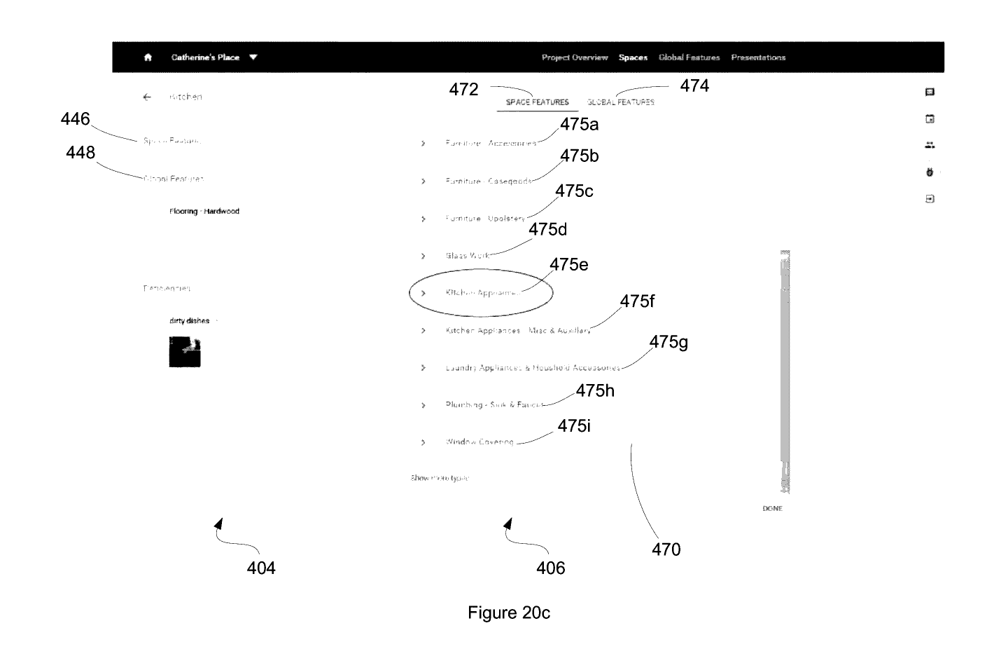

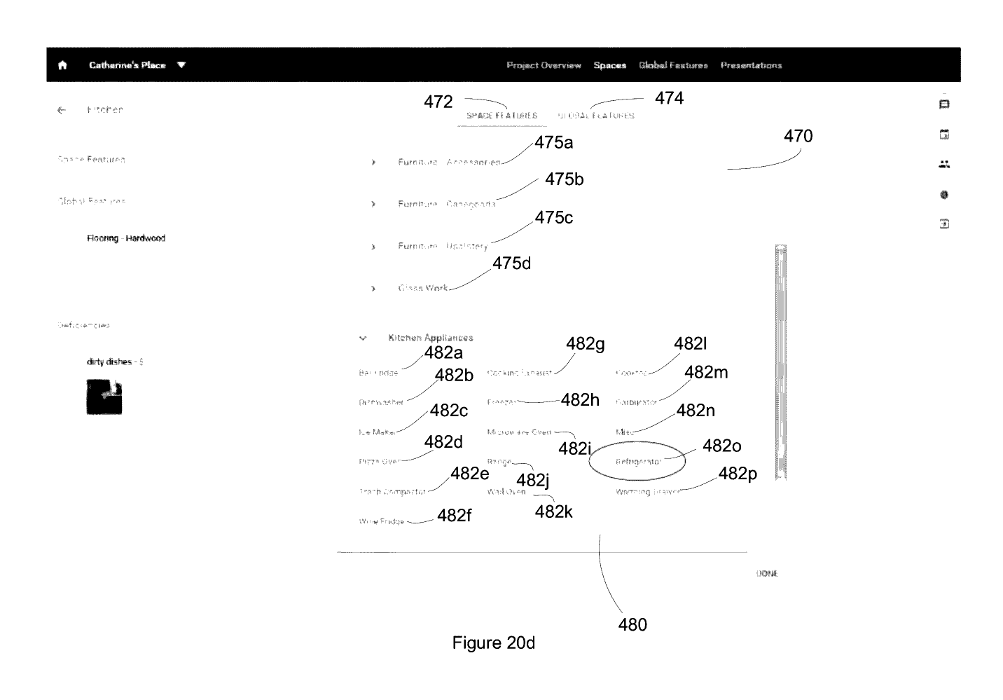

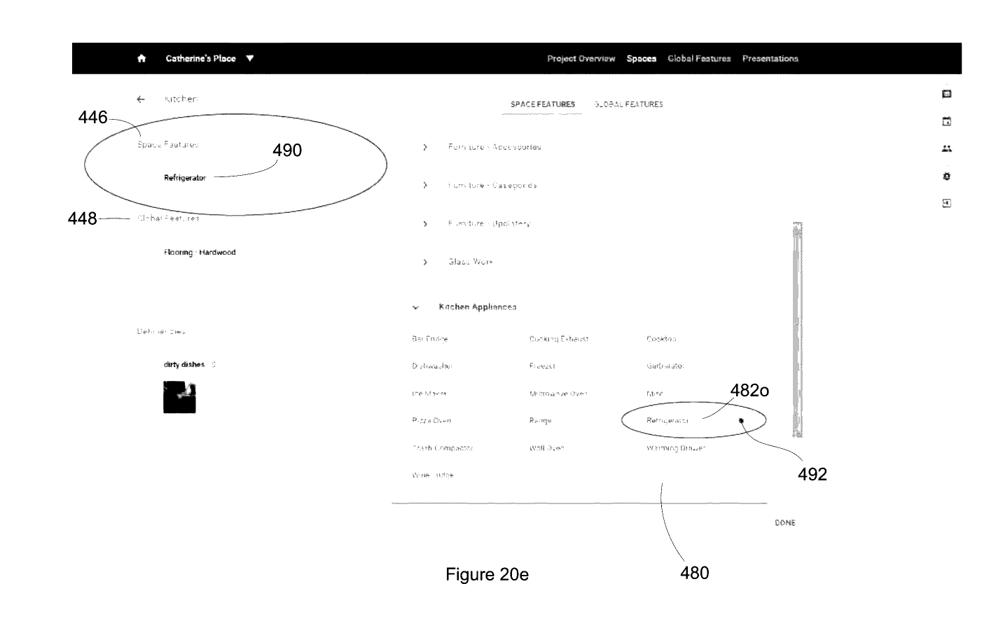

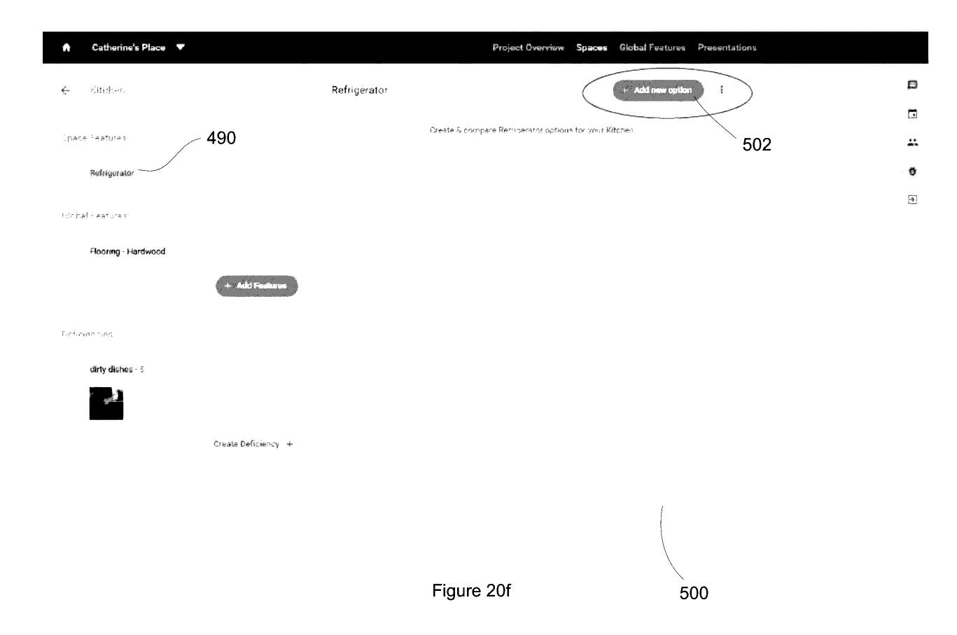

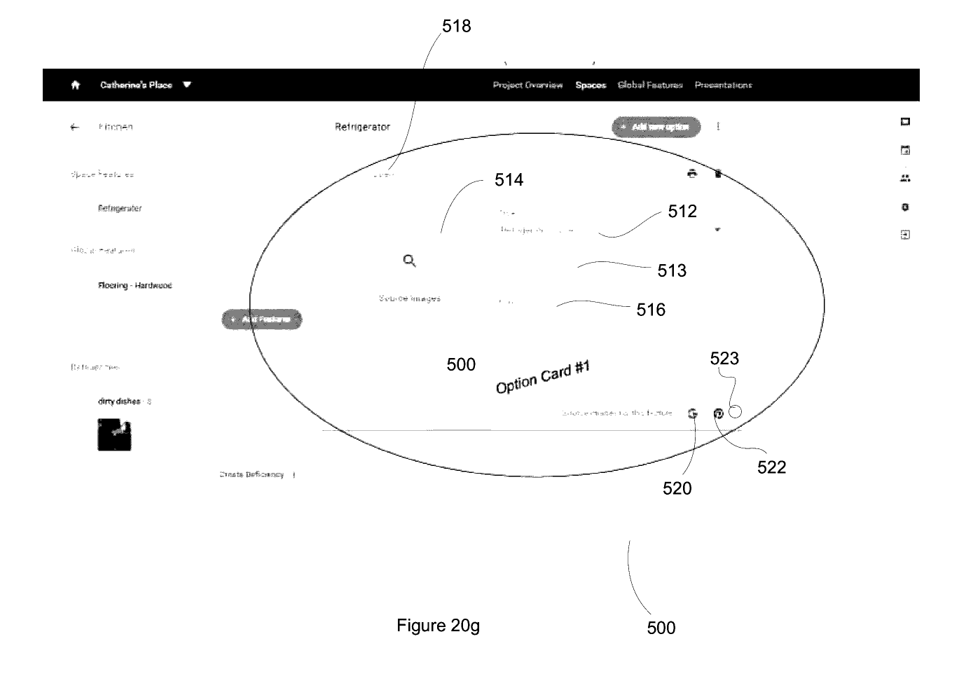

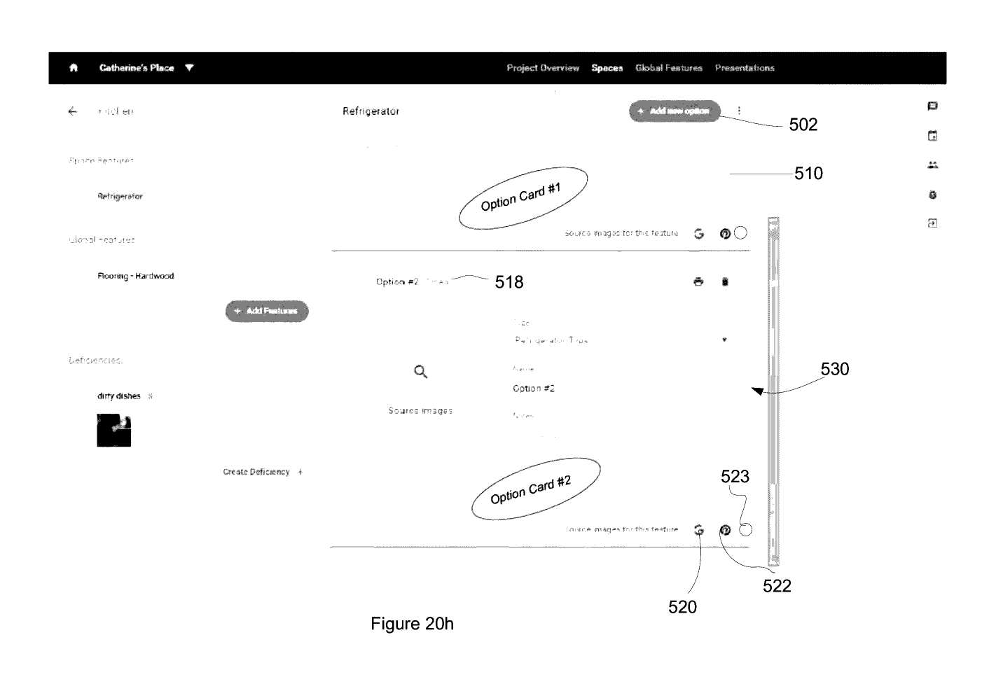

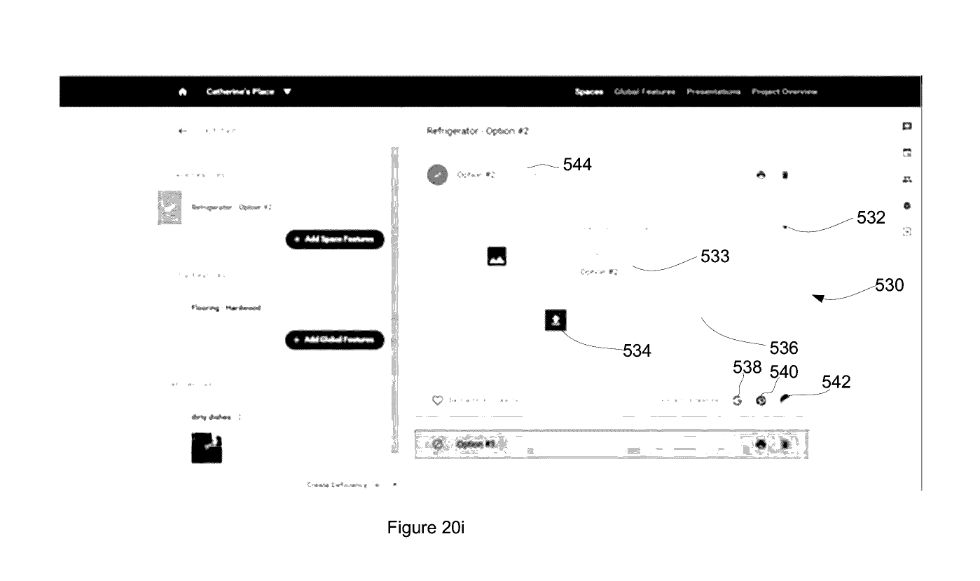

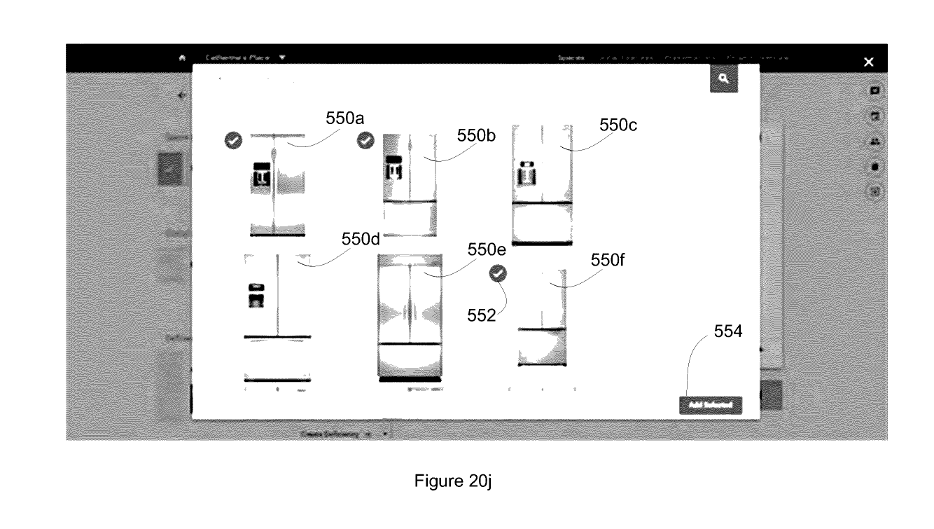

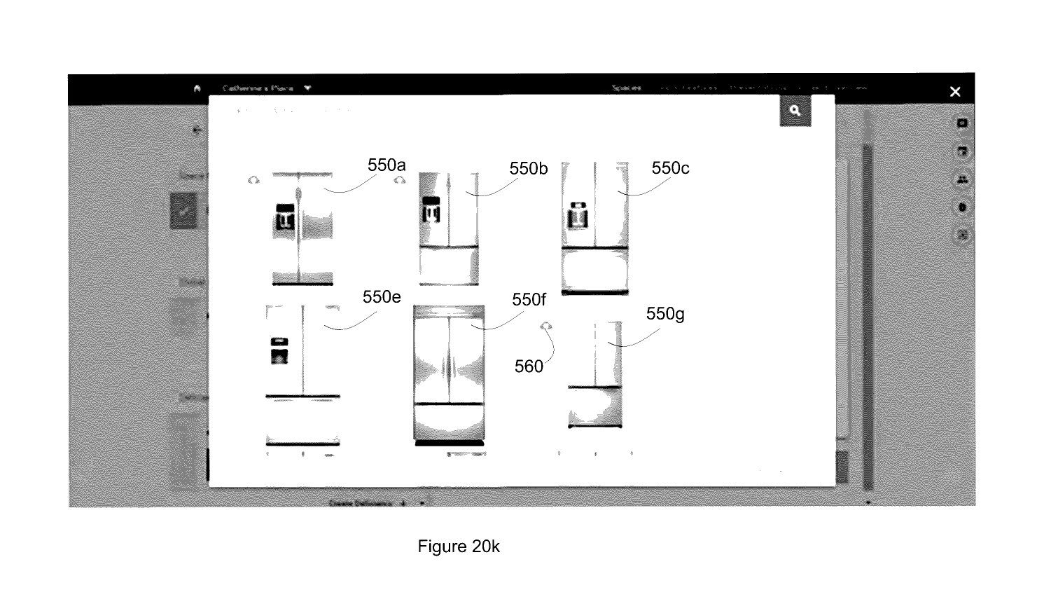

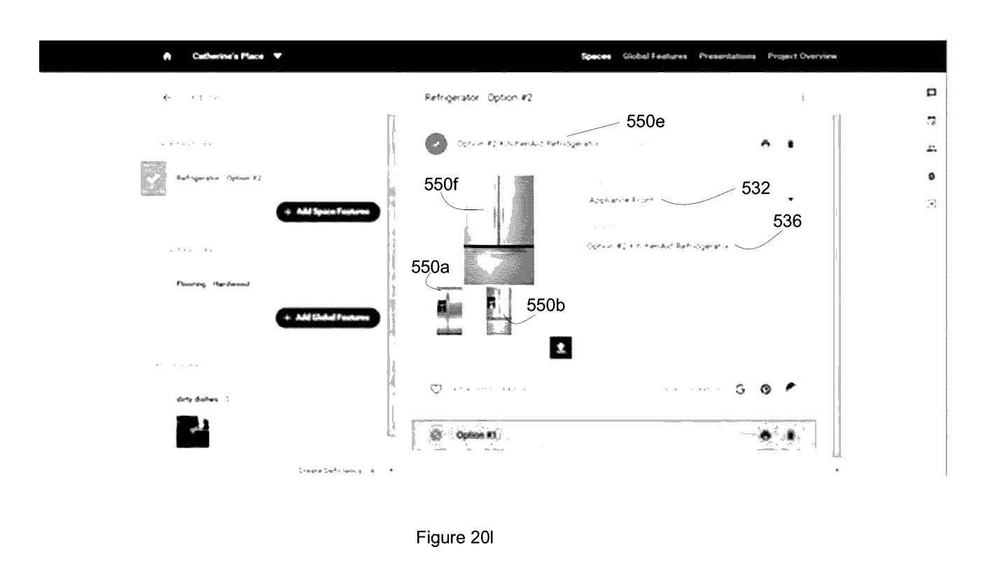

In yet another embodiment, the project management system 10 includes a space feature library and a global feature library, such that at least one feature is selected from the space feature library or a global feature library in databases 20. Turning to FIG. 20a, there is shown an exemplary GUI 400, in which a user is able to add or select a space 402 from first GUI portion 404, and features can be added to the selected space 402 in second GUI portion 406. Third GUI portion 408 includes a variety of icons 410, 412, 414, 416, and 418 associated with messaging applications, calendaring applications, collaboration applications, bug reporting applications, and a log-out button, respectively. Tool bar 420 comprises a drop-down menu 422 associated with a plurality of projects and project identifiers, a project overview tab 424, spaces tab 426, global features tab 428 and presentations tab 430. As shown in FIG. 20a, a project identified as “Catherine's Place” is selected from drop down-menu 422, and a plurality of floors associated with the building or structure, such as main floor, with associated tab 432, second floor, with associated tab 434, and building envelope, with associated tab 436, are displayed. With “Main Floor” tab 432 selected, a plurality of spaces on the main floor are displayed. These spaces include: entrance, with associated tab 440a; front hall, with associated tab 440b; hall closet, with associated tab 440c; living room, with associated tab 440d; dining room, with associated tab 440e; stairway, with associated tab 440f; kitchen, with associated tab 440h; family room, with associated tab 440h; laundry room, with associated tab 440i; powder room, with associated tab 440j; pantry, with associated tab 440k; among others. Other spaces may be added via actuation of “Add Spaces” button 442. As an example, when spaces button 440g associated with the kitchen in GUI portion 404 is selected then frame 443 associated with the kitchen space is displayed in GUI portion 404. Frame 443 includes “Kitchen” tag 444 and features, such as global features and space features, can be added to the kitchen space via “Add Features” button 445. Subsequently, added features appear under “Space Features” tag 446 or “Global Features” tag 448, and items associated with a statement of work can be added via “Add list item” input field 450. Selectable functionality control button 452 is associated with inserting images, audio and/or video objects and documents, and text or notes can be added via input field 454.

When “Add Features” button 445 is actuated overlay dialog window 460 is displayed, and includes a description and examples of space features and global features, as shown in FIG. 20b. For example, space features are generally defined as features that are found “in” a space, and are unique only to one space, such as backsplash, cabinetry, cabinetry accessories, countertops, decorative lighting, doors and access, fireplace design, furniture, furniture accessories, furniture casegoods, furniture upholstery, glasswork, kitchen appliances, kitchen appliances—miscellaneous and auxiliary, laundry appliances and household accessories, plumbing (sinks and faucets) and window coverings. Space features can be added via “Add Space Features” button 462, and each space feature is associated with a plurality option cards of which one is selected for one space in a workflow process, accordingly a space feature option card needs a space in which to exist. Correspondingly, global features such as flooring, lighting, paint, trim, doors and windows, are defined as features that go “on” a space, and can be shared among a plurality of spaces, and unlike space features, global features and corresponding global feature cards do not need a space in which to exist and can exist at the highest level of place, the project. The global features may include interior global features, exterior features, electrical features, landscaping features, and utilities features. As an example, interior global features include, but are not limited to: building safety; building safety (detection, alarm, fire): building safety (fire); ceiling; door finish; door function; door handle; door material; fabric; flooring; framing and structural; green living; grout; hardware; insulation; interior door; light type; lighting; paint; plug and switch; stain, trim-moulding; trim-stock; wall; wallpaper; window; and window film. Exterior global features include, but are not limited to: exterior ceiling; eaves trough; entry/exit doors; exterior coating; exterior walls; fascia; flashing; hydro and electrical exterior; landscaping; lightbulb; lighting; masonry; mouldings and trims; paint; roofing; signage; sills; soffit; stain and windows. Electrical global features include, but are not limited to: breaker panel; hydro meter; mains disconnect; plugs; splitter; sub-panel; switch panel; switching; transformer and vault. Landscaping global features include, but are not limited to: driveway and parking surface; lawn; plantings; pond; retaining wall; soils; stairs-outdoor; walks and paths; and water features. Utilities global features include, but are not limited to: communications; electrical service; gas service; sanitary service; and water service. Selection of any one these global features leads to the creation of a profile associated therewith, as will be described below in more detail. Global features can be added via “Add Global Features” button 464. A global feature profile may be used in many spaces, one space, or only the project.

Actuation of “Add Space Features” button 462 causes the contents of GUI portion 406 to appear in GUI portion 404, and launches space feature category type window 470 in GUI portion 406 with “Space Features” tab 472 highlighted indicative of the selected option, and “Global Features” tab 474 greyed out. Space feature category type window 470 comprises a plurality of space feature category types associated with the selected kitchen space, and these space feature category types are associated with selectable tabs, such as “Furniture Accessories” tab 475a, “Furniture—Casegoods” tab 475b, “Furniture Upholstery” tab 475c, “Glass Work” tab 475d, “Kitchen Appliances” tab 475e, “Laundry Appliances” tab 475f, “Plumbing” tab 475g and “Window Coverings” tab 475h, as shown in FIG. 20c.

Selection of “Kitchen Appliances” tab 475e in space feature category window 470 causes a display of a plurality of space feature sub-category type tabs associated with appliances suitable for the kitchen space in expanded window 480, such as “Bar Fridge” tab 482a, “Dishwasher” tab 482b, “Ice Maker” tab 482c, “Pizza Oven” tab 482d, “Trash Compactor” tab 482e, “Wine Fridge” tab 482f, “Cooking Exhaust” tab 482g, “Freezer” tab 482h, “Microwave Oven” tab 482i, “Range” tab 482j, “Wall Oven” tab 482k, “Cooktop” tab 482l, “Garburator” tab 482m, “Misc” tab 482n, “Refrigerator” tab 482o, “Warming Drawer” tab 482p, among others, as shown FIG. 20d.

Selection of “Refrigerator” tab 482o as a space feature category type 472 causes refrigerator space feature category type 472 to appear under “Space Feature” tag 446 in GUI portion 404, under “Refrigerator” control tab 490; and indicia 492 appears adjacent to “Refrigerator” tab 482, signifying selection of “Refrigerator” control tab 490, as shown in FIG. 20e.

Selection of label “Refrigerator” 490 in GUI portion 404 opens new window 500, and one or more options or attributes associated with the refrigerator that can be added by actuation of “Add new option” button 502 to create option card 510, as shown in FIG. 20f. Once created, the options or attributes associated with the refrigerator can be compared or ranked in order of importance. Referring now to FIG. 20g, it can be seen that option card 510 includes a variety of options associated with the refrigerator that can be added, such as, type of refrigerator via drop-down menu 512, and the name and model of the refrigerator can be added via input field 513. Selectable functionality control button 514 is associated with inserting content pertaining to the refrigerator, such as images, audio and/or video objects and documents, photos, and notes are added via input field 516. The content may be user generated, such as user's images or videos, or the content may be sourced from web via actuation of icons 520, 522, 523, hyperlinked to a web browser, at least one social media networking site, and a resource with user-generated content or library associated with system 10, respectively. Accordingly, all or some, of the option card category content, type, name, photos and notes are auto-populated into a search field associated with the browser, the social media networking site, resource with user-generated content or library; or the search field is left blank. Accordingly, all or some, of the option card category content, type, name, photos and notes are auto populated into a search field of the browser or the social media networking site, or local or remote library. Alternatively, a default or custom search field is located on option card 510 to search the web or social media networking site. The discovered content may be seamlessly added to option card 510 by copying and pasting, or dragging and dropping it from the web or social media networking site. Option cards 510 include a status identifier 518, such as “Open”; “Confirmed”; “Declined”; “Love”; etc. Accordingly, “Open” status identifier 518 indicates that option card 510 is open and is being updated with content; “Confirmed” status identifier 518 indicates that content has been entered and saved in memory; “Declined” status identifier 518 indicates that option card 510 has been rejected by a user or by another project participant; and “Love” status identifier 514 indicates that option card 510 ranks high in terms of desirability.

Following creation of option card 510, another option card 530 can be created by actuation of “Add new option” button 502, as shown in FIG. 20h. Referring now to FIG. 20i, it can be seen that option card 530 includes a variety of options associated with the refrigerator that can be added, such as, type of refrigerator, or sub-category type, via drop-down menu 532. As an example, the type of refrigerator may include an appliance front refrigerator, commercial refrigerator, integrated refrigerator and semi-integrated refrigerator. Input field 533 permits entry of the name and/or model of the refrigerator. Selectable functionality control button 534 is associated with inserting content pertaining to the refrigerator, such as images, audio and/or video objects and documents, photos, and notes are added via input field 536. The content may be user generated, such as user's images, audio or video, documents, text, or the content may be sourced from web via actuation of icons 538, 540, 542, hyperlinked to a web browser, at least one social media networking site, and a resource with user-generated content, or local or remote library associated with system 10, respectively. Accordingly, all or some, of the profile card category content, type, name, photos and notes are auto-populated into a search field associated with the browser, the social media networking site, resource with user-generated content or library; or the search field is left blank. Alternatively, a default or custom search field is located on option card 530 to search the web, the social media networking site, or the resource with user-generated content or library. The discovered content may be seamlessly added to option card 530 by copying and pasting, or dragging and dropping it from the web or social media networking site, or selecting it from user-generated content library. Option card 530 include a status identifier 544, such as “Open”; “Confirmed”; “Declined”; “Love”; etc. Following population of the option card 530, an appropriate status identifier 544 is chosen, such as “Confirmed”, as shown in FIG. 20i.

In one example, an appliance front refrigerator is selected from drop-down menu 532, and the brand of the appliance front refrigerator is added in input field 536 e.g. KitchenAid®, from Whirlpool Corporation, U.S.A. Actuation of icon 542 associated with user-generated content library causes a display of images of a variety of KitchenAid appliance front refrigerators 550a to 550f, as shown in FIG. 20j. A user can then select one or more of these appliance front refrigerators 550a to 550f, and a check mark indicia 552 appears adjacent the selected images. Next, actuation of “Add Selected” button 554 adds the selected images to option card 532, and check mark indicia 552 is replaced with cloud indicia 560 indicative of a successful addition or upload of the selected image, as shown in FIG. 20k.

Now looking at FIG. 20l, there is shown a populated option card 530, showing the selected KitchenAid appliance front refrigerators 550a, 550b and 550f The content library search function saves the users multiple clicks and steps when selecting and adding content to each option card 510 or 530, by eliminating the need for extra work required to add content via a copy and paste process when adding files or images to option cards 510, 530. Option card 510 is greyed out when “one” space feature card is “confirmed”, which allows a user to focus on a particular ‘chosen’ option card 530, which is beneficial when a plurality of options cards for the space feature element are present. Greying out option card 510 also minimizes any confusion by a user when reviewing the space feature category type of choice at a glance.

In addition, option cards 510 can be printed or shared or distributed electronically in whole, or in part, by the user making such as a selection from a print dialog (not shown). FIG. 22i shows an exemplary presentation user interface for all of the spaces within the project, invoked by actuation of presentations tab 430.

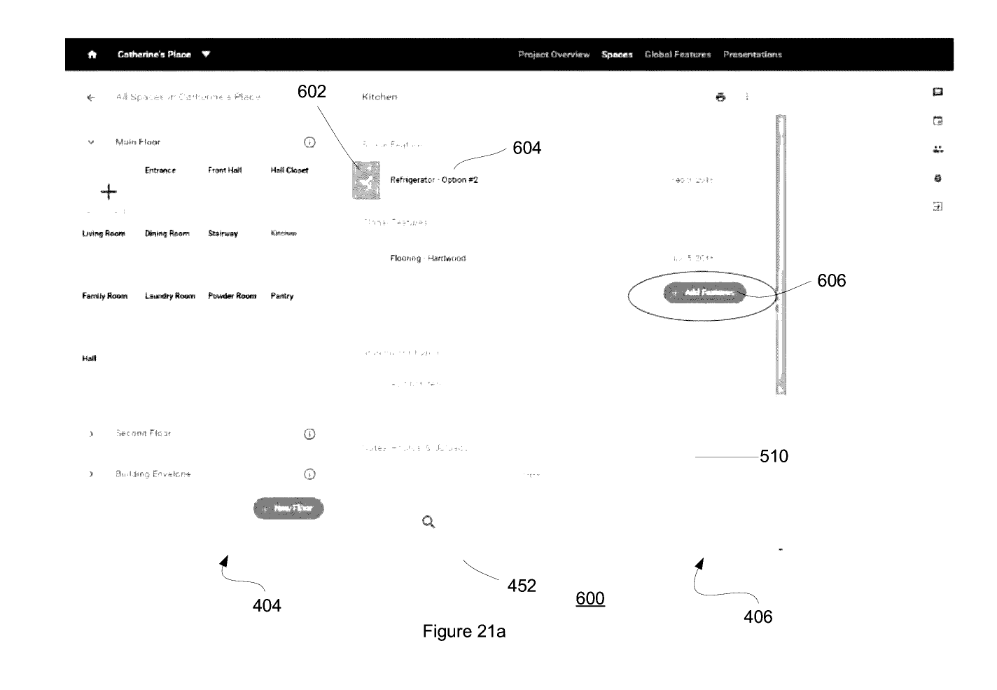

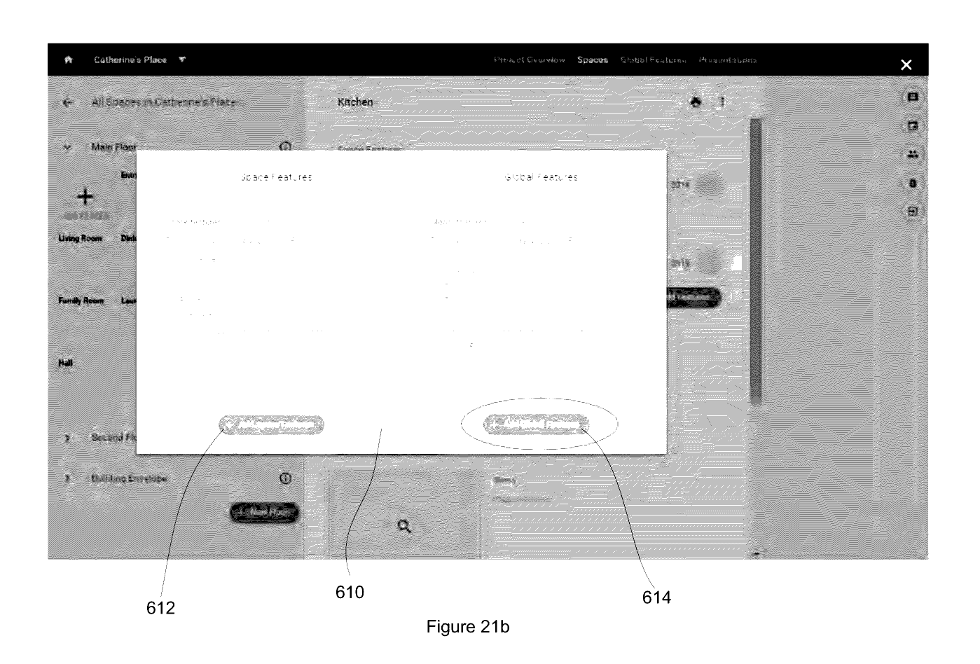

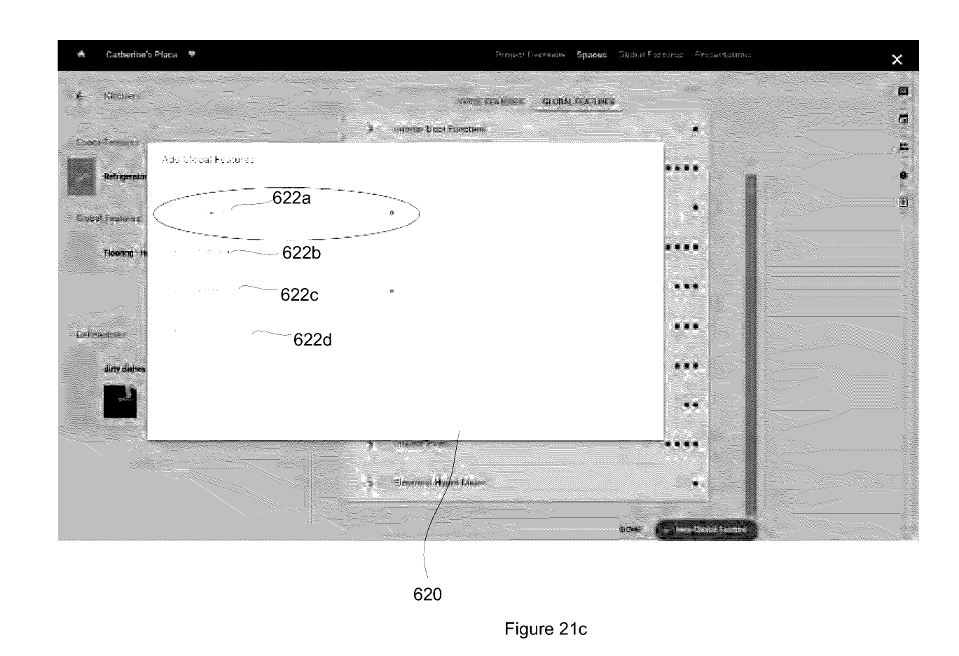

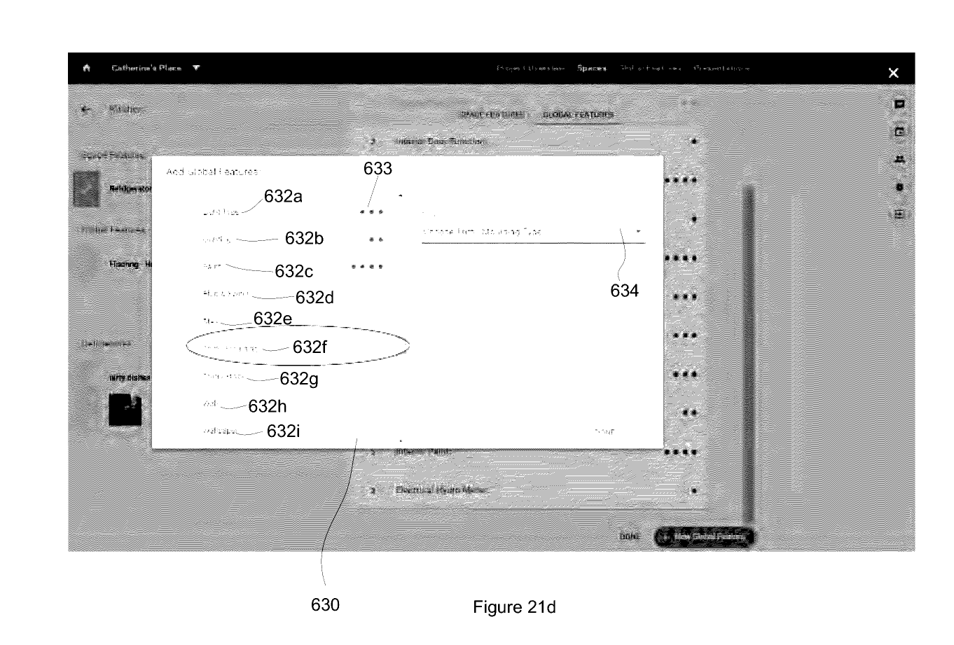

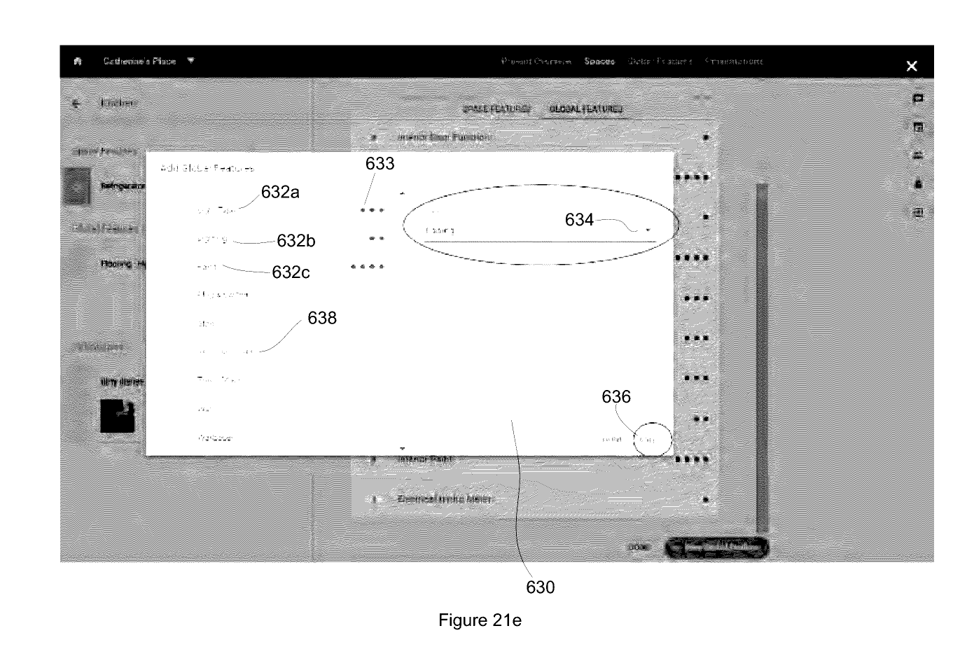

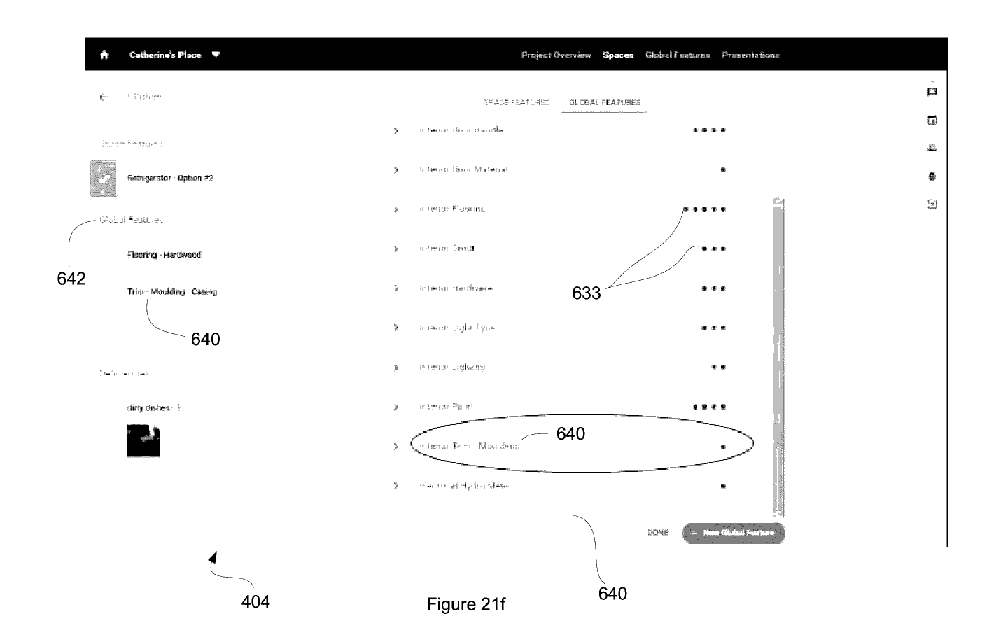

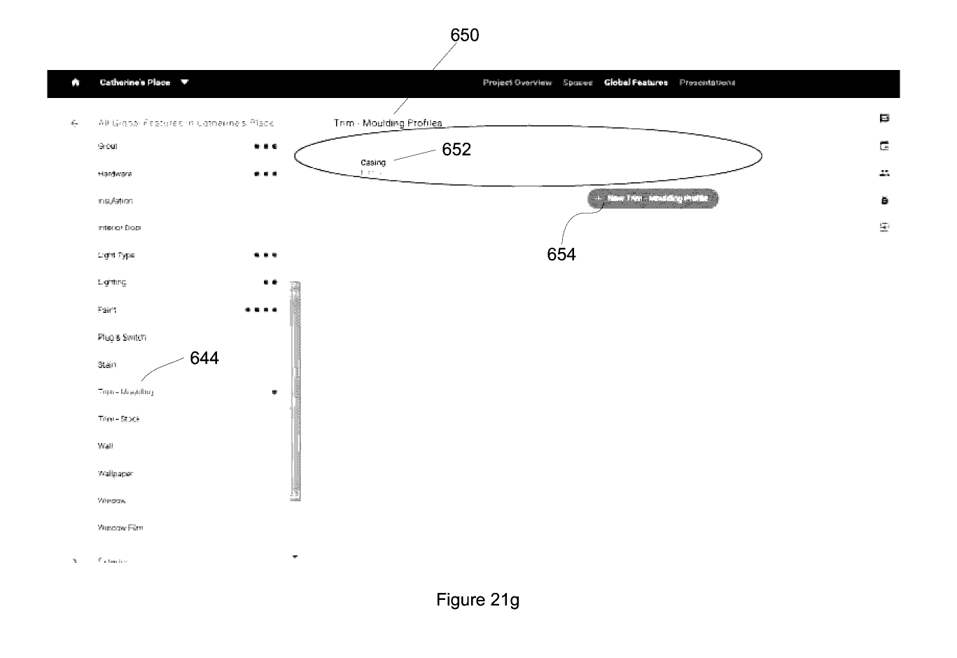

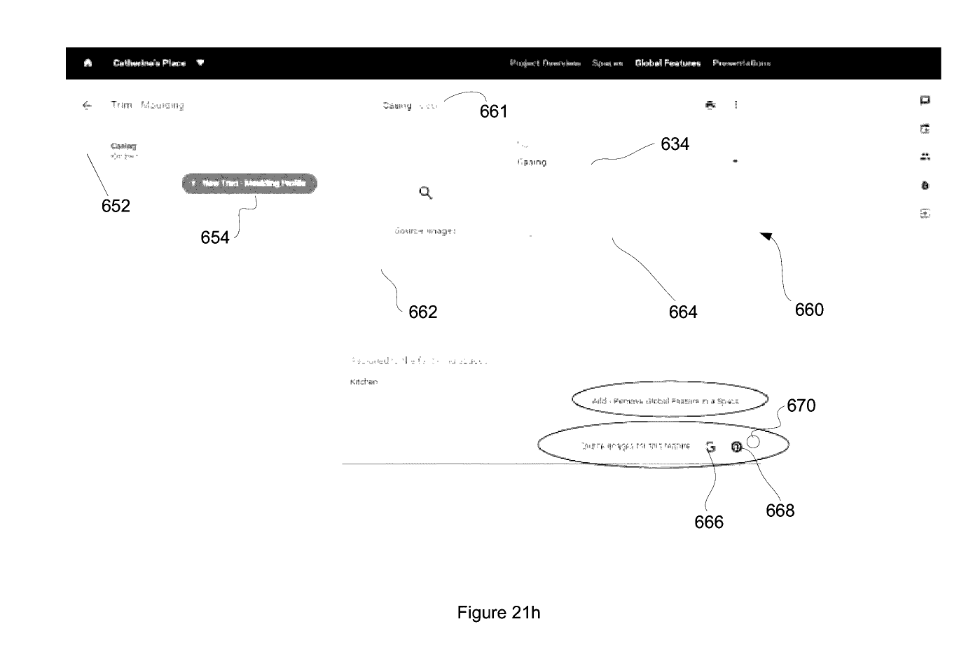

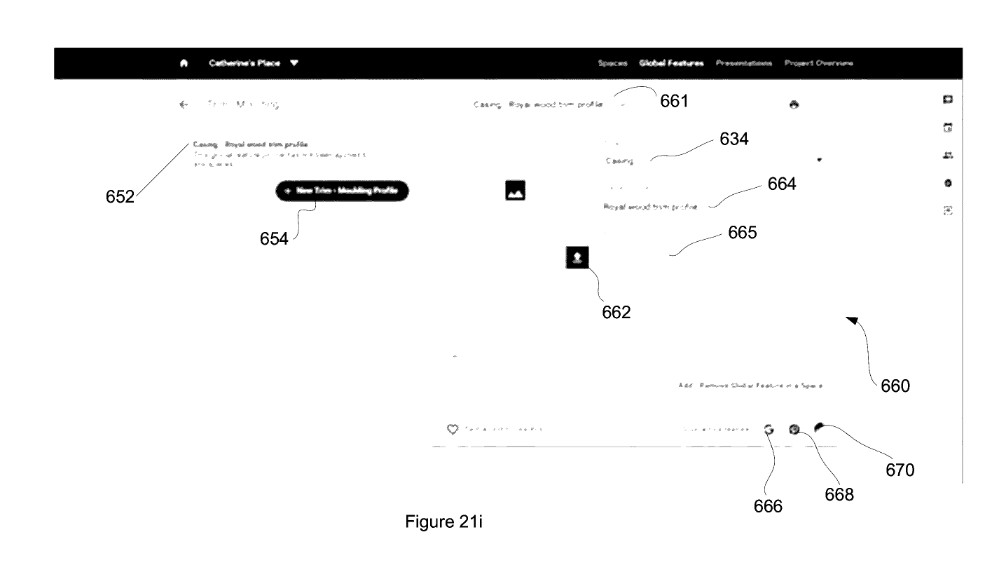

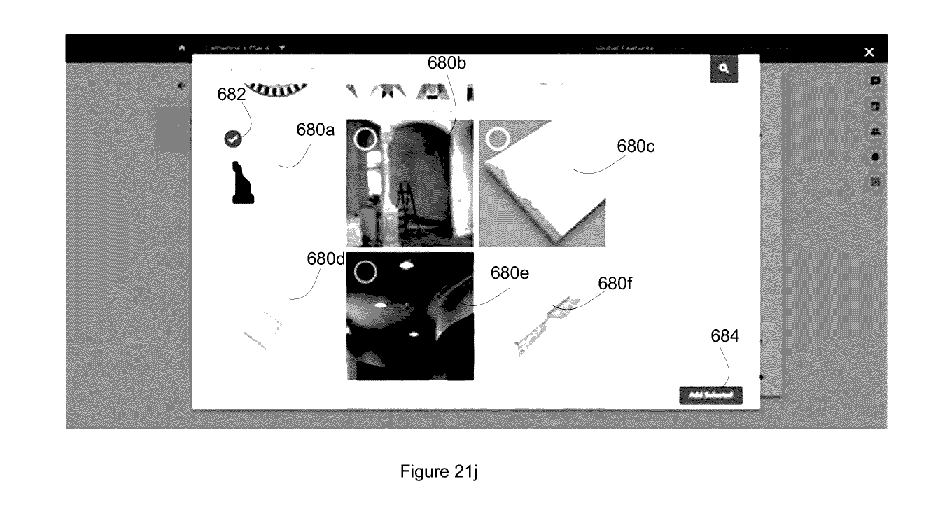

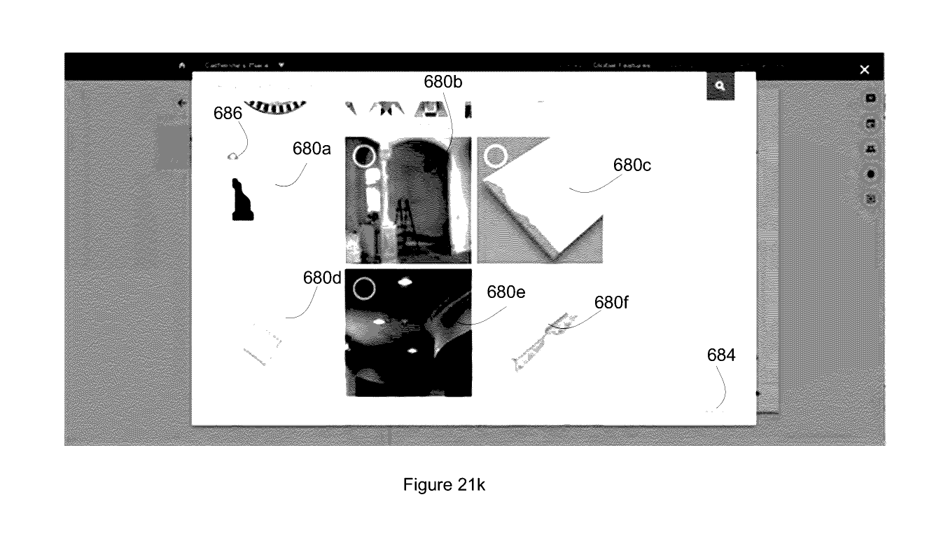

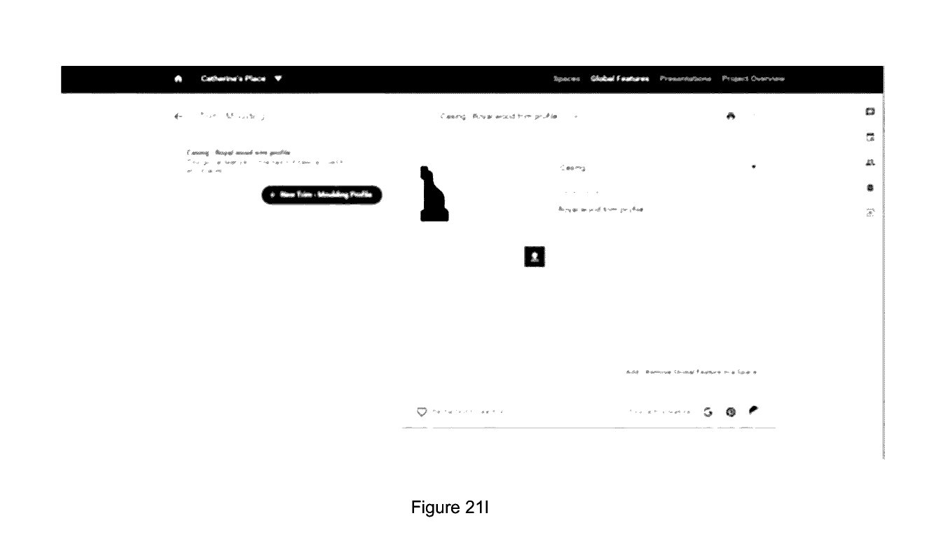

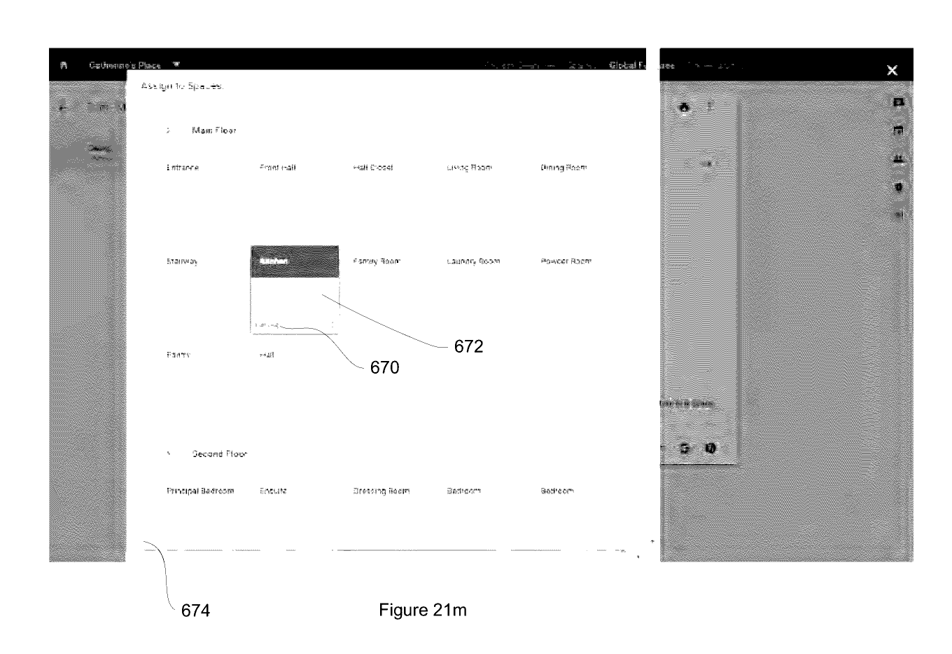

Now turning to FIG. 21a, there is shown an exemplary GUI 600, in which a user is able to add additional features to the kitchen space via “Add Features” button 604 in GUI portion 406, following the addition of space feature refrigerator 602 and associated options.

When “Add Features” button 606 is actuated overlay dialog window 610 is displayed, and includes a description and examples of space features and global features, as shown in FIG. 21b. Space features can be added via “Add Space Features” button 612 and global features can be added via “Add Global Features” button 614, as described above. As described above, a global feature profile includes a singular profile card that is selected for use in many spaces, one space, or only the project, and a global feature profile card does not need a space to exist in a project.

Actuation of “Add Global Features” button 614 launches overlay dialog window 620 with a plurality of global feature classifications with tabs associated with the selected kitchen space, such as, “Interior” tab 622a, “Exterior” tab 622b, “Electrical” tab 622c and “Landscaping” tab 622d, among others, as shown in FIG. 21c.

Actuation of “Interior” tab 622a launches overlay dialog window 630 with a plurality of interior global feature category types with associated tabs, such as “Light Type” tab 632a, “Lighting” tab 632b, “Paint” tab 632c, “Plug and Switch” tab 632d, “Stain” tab 632e, “Trim-Moulding” tab 632f, “Trim-Stock” tab 632g, “Wall” tab 632h, and “Wallpaper” tab 632i. When “Trim-Moulding” category type tab 632f is selected, a drop-down menu 634 with a plurality of selectable trim-moulding types is displayed in overlay portion 630, as shown in FIG. 21d. Indicia 633 adjacent to “Lighting” tab 632a, “Lighting” tab 632b, and “Paint” tab 632c, indicates that at least one option is associated with the interior global feature category type. Next, the trim moulding type e.g. casing is selected from drop-down menu 634, and added to the global features list by selecting “Add” button 636, and “Trim-Moulding” tab 638 is highlighted, as shown in FIG. 21e. Upon addition to the global features list, a “Trim-Moulding-Casing” tab 640 appears in GUI portion 404 under the global features tab 642 in GUI portion 404, and “Interior-Trim Moulding” tab 644 appears in GUI portion 406, as shown in FIG. 21f.

Selection of interior trim moulding tab 644 in GUI portion 406 causes the contents of GUI portion 406 to shift to GUI portion 404, while “Trim Moulding Profiles” tag 650 and “Casing” tag 652 appear in GUI portion 406, as shown in FIG. 21g. A new trim moulding profile can be added by actuating “New Trim-Moulding Profile” button 654, and the contents of GUI portion 406 appear in GUI portion 404, while a global feature profile card 660 appears in GUI portion 406, as shown in FIG. 21h. Selectable functionality control button 662 is associated with inserting content pertaining to the casing, such as images, audio and/or video objects and documents, photos, and the name/model of the global feature type 634 is noted in input field 664, while additional notes are added via input field 665. The content may be user generated, such as user's images, audio or video, documents, or the content may be sourced from web via actuation of icons 666, 668, 670 hyperlinked to a web browser, at least one social media networking site, and a resource with user-generated content or library associated with system 10, respectively. Accordingly, all or some, of the profile card category content, type, name, photos and notes are auto-populated into a search field associated with the browser, the social media networking site, resource with user-generated content or library; or the search field is left blank. Alternatively, a default or custom search field is located on profile card 660 to search the web or social media networking site. The discovered content may be seamlessly added to profile card 660 by copying and pasting, or dragging and dropping it from the web or social media networking site. Profile card 660 comprises a status identifier 661, such as “Open”; “Confirmed”; “Declined”; “Love”; and so forth.

Referring now to FIG. 20i, it can be seen that profile card 660 includes a variety of attributes associated with the trim moulding that can be added, such as, type of trim moulding via drop-down menu 634. As an example, casing is chosen from a selection of types of trim moulding comprising: architrave; backband; backer mould; bar rail; baseboard; bead mould; brick mould; burlap; casing; chair rail; corner block; cove; crown mould; crown moulding; decorative mould; door stop; jamb; jamb extension; nosing; outside corner mould; panel mould; pillaster; plinth block; quarter round; reducer; rosette; shingle mould; shoe mould; T-mould; threshold; tongue and groove; window sill/stool and wine rail.

Following population of the profile card 660, an appropriate status identifier 661 is chosen, such as “Confirmed”.

In one example, casing is selected from drop-down menu 634, and the name/model of the casing of the appliance front refrigerator is added in input field 664 e.g. Royal wood trim profile. Actuation of icon 670 associated with user-generated content library causes a display of images of a variety of casings 680a to 680f associated with the Royal wood trim profile, as shown in FIG. 20j. A user can then select one or more of these casings 680a to 680f, and a check mark indicia 682 appears adjacent the selected images, e.g. casing 680a. Next, actuation of “Add Selected” button 684 adds the selected images to profile card 660, and check mark indicia 682 is replaced with cloud indicia 686 indicative of a successful addition of the selected image, as shown in FIG. 21k. Now looking at FIG. 21l, there is shown a populated profile card 660, showing the selected casing 680a. As noted above, the library search function substantially reduces the number of steps normally required to add content to each profile card 660, compared to a copy and paste process.

In addition, profile cards 660 can be printed or shared or distributed electronically in whole or in part by user making such as a selection from a print dialog (not shown).

The created global feature is automatically assigned to the space in which it was created in. As can be seen in FIG. 21m, the ‘casing’ global feature 670 is automatically assigned to the “Kitchen” space 672. A user then can further assign the same global feature profile card 660 to more spaces from overlay dialog window 674, or global feature profile card 660 can be removed from a space. Therefore, any changes to profile content of the profile card can be applied to all of the spaces simultaneously, thereby obviating the steps of determining which spaces the profile card is associated with, and then sequentially or manually applying the profile content changes in each of the spaces. Global features do not require a space in which to exist and can exist at the project level of place only.

Server computer 14 includes a computer system with elements similar to those described above with reference to user device 12. Server computer 14 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

Server computer 14 may execute a web server application, examples of which may include but are not limited to: Microsoft IIS, Novell Webserver™, or Apache® Webserver, that allows for HTTP (i.e., HyperText Transfer Protocol) access to server computer 14 via network 16 (Webserver is a trademark of Novell Corporation in the United States, other countries, or both; and Apache is a registered trademark of Apache Software Foundation in the United States, other countries, or both). Network 16 may be connected to one or more secondary networks (e.g., network 16), examples of which may include but are not limited to: a local area network; a wide area network; or an intranet, for example.

Database 20 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention. Alternatively, database 20 is communicatively coupled to server computer 14.

The user devices 12 and server 14 may communicate with each other using network-enabled code. Network enabled code may be, include or interface to, for example, HyperText Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMWL), Wireless Markup Language (WML), Java™, Java™ Beans, Enterprise Java™ Beans, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

While the project management module 18 is shown and described as residing on, and being executed by, server computer 14, other implementations may equally be utilized. For example, the project management module may be a client-side process stored on one or more storage devices resident on, or coupled to one or more client user devices 12. In such an implementation, the project management module 18 may be a stand-alone application or an applet/application that is executed within a client application. As such, project management module 18 may be a server-side process executed on server computer 14, a client-side process executed by one or more client user devices 12, or a hybrid client-side/server-side process, executed in part by server computer 14 and one or more client user devices 12.

In another embodiment, system 10 may be an enterprise system.

One or more portions of the computer system 12 may be distributed across one or more computer systems coupled to a communications network. This computer system 12 also may be general-purpose computer system. The computer system 12 may be in the form of any kind of general processing structure, and may for example include any device, such as, a personal computer, laptop, tablet, computer server, personal digital assistant (PDA), cellular phone, smartphone. For example, various aspects of the invention may be distributed among one or more computer systems (e.g., servers) configured to provide a service to one or more client computers, or to perform an overall task as part of a distributed system. For example, various aspects of the invention may be performed on a client-server, hybrid client-server, or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

The communications network 16 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. In a project management system, a computer-implemented method for managing information related to at least one project; said method having instructions stored in a computer-readable medium and executable by a processing structure to cause said processing structure to at least:
receive a user-defined project identifier associated with said at least one project;
assign a unique place identifier to a location of said at least one project, and store said unique place identifier to form a first level of a hierarchical data structure in a database;
assign a unique sub-place identifier to at least one sub-location of said at least one project, and store said unique sub-place identifier to form a second level of said hierarchical data structure in said database;
provide a first workflow process customized for said at least one project, and said first workflow process comprising at least one space feature category type associated with said at least one location and/or said at least one sub-location, and provide a second workflow process customized for said at least one project, and said second workflow process comprising at least one global feature category type associated with a plurality of said at least one locations and/or said at least one sub-locations;
provide a space feature library having a plurality of said at least one space feature category types corresponding to said first workflow process, and a global feature library having a plurality of said at least one global feature category types corresponding to said second workflow process; and
receive a selection of at least one of said first workflow process and said second workflow process for use in said at least one project.

2. The system of claim 1, wherein said space feature library for at least one of a construction, renovation, remodel, interior design and build project comprises said plurality of said at least one space feature category types to be associated with said at least one location and/or said at least one sub-location, and not commonly associated with more than one of said at least one location and/or said at least one sub-location.

3. The system of claim 2, wherein said space feature library for at least one of a construction, renovation, remodel and build project has said plurality of said at least one space feature category types comprising at least one of a: backsplash, cabinetry, cabinetry accessories, countertops, decorative lighting, doors and access, fireplace design, furniture, furniture accessories, furniture casegoods, furniture upholstery, glasswork, kitchen appliances, miscellaneous and auxiliary kitchen appliances, laundry appliances and household accessories, plumbing and window coverings.

4. The system of claim 3, wherein said at least one space feature category type comprises at least one option card having at least one of an image, audio, video and text, and wherein each of said least one option cards is a selectable choice for inclusion in said project.

5. The system of claim 4, wherein said global feature library comprises a plurality of said at least one global feature category types to be associated with a plurality of said at least one locations and/or said at least one sub-locations, and are common to more than one of said at least one locations and/or said at least one sub-locations.

6. The system of claim 5, wherein said at least one global feature for at least one of a construction, renovation, remodel and build project comprises at least one of interior global features, exterior global features, electrical global features, landscaping global features, and utilities global features.

7. The system of claim 6, wherein said interior global features comprise: building safety; ceiling; door finish; door function; door handle; door material; fabric; flooring; framing and structural; green living; grout; hardware; insulation; interior door; light type; lighting; paint; plug & switch; stain, trim-moulding; trim-stock; wall; wallpaper; window; and window film.

8. The system of claim 7, wherein said exterior global features comprise: exterior ceiling; eaves trough; entry/exit doors; exterior coating; exterior walls; fascia; flashing; hydro and electrical exterior; landscaping; lightbulb; lighting; masonry; mouldings and trims; paint; roofing; signage; sills; soffit; stain and windows.

9. The system of claim 8, wherein said electrical global features comprise: breaker panel; hydro meter; mains disconnect; plugs; splitter; sub-panel; switch panel; switching; transformer and vault.

10. The system of claim 9, wherein said landscaping global features comprise: driveway and parking surface; lawn; plantings; pond; retaining wall; soils; outdoor stairs; walks and paths; and water features.

11. The system of claim 10, wherein said utilities global features include communications; electrical service; gas service; sanitary service; and water service.

12. The system of claim 11, wherein said at least one global feature category type comprises at least one profile card having profile content comprising at least one of an image, audio, video and text, and wherein each of said least one profile cards is a selectable choice for inclusion in said project.

13. The system of claim 12, wherein any changes to said profile card content of said at least one profile card is applied to said plurality of said at least one locations and/or said at least one sub-locations simultaneously, thereby obviating the steps of determining which of said plurality of said at least one locations and/or said at least one sub-locations said at least one profile card is associated with, and sequentially or manually applying said changes to said profile content in each of said plurality of said at least one locations and/or said at least one sub-locations.

14. The system of claim 13, wherein an electronic message having at least one of said profile card and option card created; and said electronic message is provided to at least one project participant, and wherein said message pertains to said at least one location and/or said at least one sub-location, such that said message is location-centric rather than project participant-centric.

15. A computer program product comprising a non-transitory computer readable medium embodying computer readable code for managing information related to at least one project, said computer program product comprising:
computer readable code for creating a window on a graphical user interface to include at least one location and at least one sub-location pertaining to said project and at least one project element type pertaining to one of said location and said at least one sub-location;
responsive to user selection of said at least one location and said at least one sub-location, computer readable code for displaying an object attributes window including a plurality of selectable attributes associated with said at least one location, said at least one sub-location;
provide a first workflow process customized for said at least one project, and said first workflow process comprising at least one space feature category type associated with said at least one location and/or said at least one sub-location, and provide a second workflow process customized for said at least one project, and said second workflow process comprising at least one global feature category type associated with a plurality of said at least one locations and/or said at least one sub-locations;
provide a space feature library having a plurality of said at least one space feature category types corresponding to said first workflow process, and a global feature library having a plurality of said at least one global feature category types corresponding to said second workflow process; and
receive a selection of at least one of said first workflow process and said second workflow process for use in said at least one project.

16. The computer program product of claim 15, wherein said space feature library comprises a plurality of said at least one space feature category types to be placed in said at least one location and/or said at least one sub-location, and not commonly associated with more than one of said at least one location and/or said at least one sub-location.

17. The computer program product of claim 16, wherein said global feature library comprises a plurality of said at least one global feature category types to be placed in a plurality of said at least one locations and/or said at least one sub-locations, and are common to more than one of said at least one locations and/or said at least one sub-locations; and
wherein said at least one space feature comprises at least one option card having at least one of an image, audio, video and text, and wherein each of said least one option card is a selectable choice for inclusion in said at least one project; and
wherein said at least one global feature category type comprises at least one profile card having at least one of an image, audio, video and text, and wherein each of said least one profile card is a selectable choice for inclusion in said at least one project.

18. The computer program of claim 17, wherein any changes to said profile content of said at least one profile card is applied to said plurality of said at least one locations and/or said at least one sub-locations simultaneously, thereby obviating the steps of determining which of said plurality of said at least one locations and/or said at least one sub-locations said at least one profile card is associated with, and sequentially or manually applying said changes to said profile content in each of said plurality of said at least one locations and/or said at least one sub-locations.

19. The computer program of claim 18, wherein any of said customized workflow processes pertains to a workflow process in a field of at least one of construction, renovation, remodeling, interior design; construction; architecture, engineering, commercial, manufacturing, institutional, government, healthcare, education, law enforcement, military, event planning, movie entertainment and production, consumer and travel.

20. A communication method between a plurality of participants associated with a project, said project having at least one task comprising a plurality of sub-tasks, the method having the steps of:
associating least one task with at least one hierarchical level of said project;
organizing at least one object type pertaining to said project, said at least one object type comprising one of said location, time, personnel, equipment, products, services;
assigning at least one attribute to said at least one hierarchical level of said project and said at least one of object type, wherein said at least one attribute comprises at least one of a feature, metrics, descriptive information, personnel, time, work, said at least one task, said at least one sub-task, communications, notes, and media;
composing a message related to said at least one hierarchical level and said at least one selectable attribute by:
selecting said at least one hierarchical level and said at least one selectable attribute and populating an editable free-form user interface element; and
wherein said message comprises said at least one hierarchical level as an originator of said message, and said at least one attribute forms a subject of said message, and said free-form content forms a body of said message; and
wherein said at least one hierarchical level and said at least selectable attributes contribute to a communication method that is centered about said at least one hierarchical level rather than said project participants.

21. The communication method of claim 20, further comprising a first workflow process customized for said project, and said first workflow process comprising at least one level feature category type associated with said at least one level and provide a second workflow process customized for said project, and said second workflow process comprising at least one global feature category type associated with a plurality of said at least one levels;
provide a level feature library having a plurality of said at least one level feature category types corresponding to said first workflow process, and a global feature library having a plurality of said at least one global feature category types corresponding to said second workflow process; and
receive a selection of at least one of said first workflow process and said second workflow process for use in said project.

22. The communication method of claim 21, wherein said at least one level feature category type is associated with at least one sub-level, and at least one global feature category type is associated with a plurality of said at least one sub-levels.

23. The communication method of claim 22, wherein any of said customized workflow processes pertains to a workflow process in a field of at least one of construction, renovation, remodeling, interior design; construction; architecture, engineering, commercial, manufacturing, institutional, government, healthcare, education, law enforcement, military, event planning, movie entertainment and production, consumer and travel.
